(19) United States
(12) Patent Application Publication
(10) Pub. No.: US 2020/0179213 A1
(43) Pub. Date: Jun. 11, 2020

(54) UPPER TORSO AUGMENTATION SYSTEM AND METHOD

(71) Applicant: Abilitech Medical, Inc., Minneapolis, MN (US)

(72) Inventors: Eli Krumholz, Minneapolis, MN (US); Rob Wudlick, Minneapolis, MN (US); John Zentgraf, Minneapolis, MN (US); Angie Conley, Minneapolis, MN (US); Rob Roberts, Minneapolis, MN (US); Chris Narveson, Minneapolis, MN (US)

(21) Appl. No.: 16/468,926

(22) PCT Filed: Dec. 12, 2017
(86) PCT No.: PCT/US17/65782

§ 371 Date: Jun. 12, 2019

Related U.S. Application Data
(60) Provisional application No. 62/468,566, filed on Mar. 8, 2017.

(51) Int. Cl. A61H 1/02

(52) U.S. Cl. CPC A61H 1/0281; A61H 1/0277; A61H 2201/1616; A61H 2201/5061; A61H 2201/1652; A61H 2201/5007; A61H 2201/1638

(57) ABSTRACT

An upper torso augmentation system configured to augment a native strength of an arm of the user by aiding movement of the arm. The upper torso augmentation system including a body chassis configured to be worn around a torso of the user, the shoulder assembly pivotably coupled to the body chassis, and an upper arm assembly pivotably coupled to the shoulder assembly, the upper arm assembly including an assisted force mechanism, wherein an output of the assisted force mechanism is adjustable via a first adjustment mechanism and a second adjustment mechanism thereby enabling the output to approximate a determined minimum assist force required for the user to move their arm through a desired range of motion, so as to minimize any excess torque produced by the upper torso augmentation system.

### RELATED APPLICATION INFORMATION

The present application is a National Phase entry of PCT Application No. PCT/US2017/065782, filed Dec. 12, 2017, which claims priority to U.S. Provisional Application No. 62/468,566 filed Mar. 8, 2017, said application being hereby incorporated by reference in its entirety.

### TECHNICAL FIELD

The present disclosure relates generally to systems and methods for upper extremity lift and assist of patients suffering from a loss of motor skills. More particularly, the present disclosure relates to an upper torso augmentation system and method of use, configured to augment existing upper body movement and rebuild lost motor skills in patients suffering from neuromuscular disorders, spinal injuries, or impairment of limbs as a result of a stroke.

### BACKGROUND

Individuals with neuromuscular abnormalities, such as neuromuscular disorders, spinal injuries, or impairment of limbs as a result of a stroke, often experience muscular atrophy and/or impaired motor function, which can lead to a loss of full functionality in their limbs and upper body. Such a loss in functionality can make the performance of routine tasks difficult, thereby adversely affecting the individual's quality of life.

In the United States alone, 1.4 million people suffer from neuromuscular disorders. It is estimated that approximately 45,000 of these people are children, who are affected by one or more pediatric neuromuscular disorders. Pediatric neuromuscular disorders include Spinal Muscular Atrophy (SMA), cerebral palsy, Arthrogryposis Multiplex Congenital (AMC), Becker Muscular Dystrophy, and Duchenne Muscular Dystrophy (DMD). Adult neuromuscular diseases include Multiple Sclerosis (MS), Amyotrophic Lateral Sclerosis (ALS) and Facioscapulohumeral Muscular Dystrophy (FSHD). Many of these muscular disorders are progressive, such that there is a slow degeneration of the spinal cord and/or brainstem motor neurons resulting in generalized weakness, atrophy of skeletal muscles, and/or hypotonia.

In the United States, approximately 285,000 people suffer from spinal cord injuries, with 17,000 new cases added each year. Approximately 54% of spinal cord injuries are cervical injuries, resulting in upper extremity neuromuscular motor impairment. Spinal cord injuries can cause morbid chronic conditions, such as lack of voluntary movement, problematic spasticity, and other physical impairments which can result in a lower quality of life and lack of independence.

In the United States, it is estimated that there are over 650,000 new surviving stroke victims each year. Approximately 70-80% of stroke victims have upper limb impairment and/or hemiparesis. Numerous other individuals fall victim to Silent Cerebral Infarctions (SCI), or “silent strokes,” which can also lead to progressive limb impairment. Complications from limb impairment and hemiparesis may involve spasticity, or the involuntary contraction of muscles when an individual tries to move their limb. If left untreated, the spasticity can result in the muscles freezing in abnormal and painful positions. Also, following a stroke, there is an increased possibility of developing hypertonicity, or the increased tightness of muscle tone.

In many cases, a reduction in strength or impairment of motor function, as a result of neuromuscular abnormalities, can be slowed, stopped, or even reversed through active treatment and therapy. At least for stroke victims, data suggests that the sooner that the therapy is started after the impaired motor function is first noticed, and the greater the amount of therapy that is performed by the patient, the more likely the patient is to have a better recovery. Unfortunately, the therapy often utilizes expensive equipment and is limited to in-clinic settings, thereby significantly restricting the amount of therapy that can be performed by the patient.

In other cases, such as with progressive neuromuscular disorders, the goal of the treatment may be to slow the decline in functionality, so as to maintain the individual's quality of life for as long as possible. Common treatment methods include physical therapy combined with medications to provide symptomatic relief. Recent advances in orthotic exoskeletons for patients with degenerative muscle disorders have been very limited. Most exoskeletons have been designed with active power sources for in clinic treatment; however, some passively powered devices have also been developed. One example of a passively powered device for the treatment of neuromuscular disorders is disclosed in U.S. Pat. No. 6,821,259 (assigned to the Nemours Foundation), the contents of which are incorporated by reference herein.

Regarding spinal cord injuries, while there are no known treatments that can reverse morbidities, neuromuscular electrical stimulation, repetitive high-intensity exercise, and the use of orthotics and exoskeletons have been used to improve the strength and overall neuromuscular health of patients. In particular, a number of arm support devices have been used by patients to strengthen upper extremities and improve independence for accomplishing activities of daily living. Nevertheless, continuous use of these devices throughout daily life is limited by their high cost, bulk, weight, lack of comfort, and limited functionality.

One form of therapy used for the treatment of neuromuscular abnormalities is commonly referred to as Constraint Induced Movement Therapy (CIMT). CIMT is a therapeutic method that involves restricting a patient's “good” limb (i.e., non-paretic limb), while exercising the affected or paretic limb. CIMT is a superior method for combating learned-nonuse, a phenomenon where, after a period of nonuse, the patient forgets how to use the paretic limb. The traditional protocol for CIMT involves: intensive graded practice of the paretic limb aimed at enhancing task specific use of the paretic limb for up to six hours a day for two weeks; constraining the non-paretic limb with, for example, a mitt, to promote use of the paretic limb during 90% of waking hours; and adherence-enhancing behavioral methods designed to transfer the gains obtained in the clinical setting or laboratory to the patient's real-world environment.

Often the CIMT method is implemented via a device. One such example of a device is the Hocoma Armeo Spring, as disclosed in U.S. Pat. No. 8,192,331, which is incorporated by reference herein. Software for use in conjunction with this device is disclosed in U.S. Patent Publ. No. 2009/0076351, which is also incorporated by reference herein. Although the data concerning the use of the CIMT method has proven effective, the large cost and the immobility of current devices for implementation of the CIMT method, inhibit the method from being widely used outside of the in-clinic setting.

In addition to restriction to the in-clinic setting, another deficiency of devices used to implement CIMT methods is the lack of an ability to guide the patient's limb movements through preferred pathways. Preferred pathway motion control has been shown to optimize completion of Activities of Daily Living (ADL) and reinforce the long held tenant of rehabilitation therapy to focus on “high quality” limb movements, rather than pathways of lesser quality that are easiest for the patient to perform.

### SUMMARY OF THE DISCLOSURE

Embodiments of the present disclosure provide for low-profile, modular ambulatory devices and methods for user's with neuromuscular disorders. Embodiments of the present disclosure enable users to experience an improved range of motion, thereby improving independence, enabling the completion of activities of daily living (ADL), and/or to reinforce therapeutic regimens (e.g., CIMT or repetitive motion). Some embodiments of the present disclosure enable improved functional movement within a high-frequency of use zone or a prioritized three-dimensional range of motion defined as an anterior three-dimensional cone. Some embodiments of the present disclosure include lift and assist devices having dual upper and forearm adjustments that can be configured by a firmware base control system to augment a user's intrinsic muscle strength and/or to provide lift to an otherwise immobile arm. Mechanical adjustments combined with firmware controlled modes of operation enable the user to balance both torque and load requirements to complete ADLs. Embodiments of the present disclosure can be passively powered, actively powered, or a hybrid of passive and active powered. Embodiments of the present disclosure can include a hybrid passive-direct and active-indirect drive assembly. Embodiments of the present disclosure can further amplify known therapy methods by enabling automatic tracking of movements and grading of tasks through an integrated mobile computing device during extended use throughout the period of use.

One embodiment of the present disclosure provides an upper torso augmentation system configured to augment a native strength of an arm of a user by aiding movement of the arm. The upper torso augmentation system can include a body chassis, a shoulder assembly, and an upper arm assembly. The body chassis can be configured to be worn around the torso of the user. The shoulder assembly can be pivotably coupled to the body chassis. The upper arm assembly can be pivotably coupled to the shoulder assembly. The upper arm assembly can include an assisting force mechanism that provides an additional force to it movement of the arm, wherein the additional force of the assisting force mechanism is adjustable via a first adjustment mechanism and a second adjustment mechanism, thereby enabling the additional force to approximate a determined minimum assist force required for the user to move their arm through a desired range of motion.

In some embodiments, the assisting force mechanism includes a biasing element configured to rotate a rigid member about a pivot. In some embodiments, the biasing element is a compression spring. In some embodiments the first adjustment mechanism shifts the biasing element relative to at least one rigid member and/or the pivot. In one embodiment, the first adjustment mechanism comprises a shiftable preload assembly, in which the biasing element is housed in a shuttle shiftable within a channel defined in the rigid member. In one embodiment the assisting force mechanism further includes a cable traversing between the biasing element any coupling point. In one embodiment, the second adjustment mechanism shifts the coupling point relative to at least one of the rigid member and/or the biasing element. In one embodiment, the second adjustment mechanism is a lever configured to rotate about the pivot. In one embodiment, the upper torso augmentation system further comprises a lower arm assembly pivotably coupled to the upper arm assembly. In one embodiment, the lower arm assembly includes a lower arm assisting force mechanism in which an output is adjustable to a desired range of motion.

Another embodiment of the present disclosure provides an upper torso augmentation system configured to augment the native strength of an arm of a user by aiding movement of the arm. The upper torso augmentation system can include a body chassis, a shoulder assembly, and an upper arm assembly. The body chassis can be configured to be worn around a torso of the user. The shoulder assembly can be pivotably coupled to the body chassis. The upper arm assembly can be pivotably coupled to the shoulder assembly. The upper arm assembly can include a hybrid assisting force mechanism that provides an additional force to aid movement of the arm, wherein the additional force of the hybrid assisting force mechanism is produced by a passively powered biasing mechanism, and the passively powered biasing mechanism is adjustable via an actively powered adjustment mechanism, thereby enabling the additional force to approximate a determined minimum assist force required to move the arm through a desired range of motion.

Another embodiment of the present disclosure provides a method for optimizing an additional force of an upper torso augmentation system configured to augment a native strength of an arm of a user by aiding movement of the arm through a desired range of motion. The method including the steps of: determining the native strength of the arm at one or more points along the desired range of motion; determining a minimum assist force requirement necessary to move the arm and portions of the upper torso augmentation system through the desired range of motion; and adjusting a first adjustment mechanism and a second adjustment mechanism to tailor the additional force of the upper torso augmentation system to approximate the determined minimum assist force requirement.

In some embodiments, determining the native strength can involve measuring the maximum force that the user is able to generate when pivoting at least one of their upper arm about their shoulder and/or their forearm about their elbow. In some embodiments, determining a minimum assist force requirement is computed by subtracting the determined native strength from a total force requirement to move both the arm and the upper torso augmentation through the desired range of motion. In some embodiments, the total force requirement is a sum of the native strength and an assistance force generated by the upper torso augmentation system sufficient to enable movement of the arm and portions of the upper torso augmentation system through the desired range of motion. In some embodiments, the total force requirement is determined based on a known weight of portions of the upper torso augmentation system and at least one of an estimated or actual weight of the arm.

Upper torso augmentation can be accomplished through a passively powered assembly configured to utilize stored potential energy to provide a passive lifting force to the user's arm in order to augment the user's native strength to at least partially counteract the effects of gravity. Upper torso augmentation can also be accomplished through a hybrid power source of both passive and actively powered assist assemblies. In some embodiments, an actively powered assist assembly can be used to adjust the output of a passive system. Utilizing an actively powered assist assembly to adjust the output of a passive system, rather than directly providing an active lifting force reduces weight and bulk of the components (e.g., lighter weight actuators may be utilized), and significantly reduces battery consumption, such that a smaller, lighter weight battery may be utilized.

One embodiment of the present disclosure provides a hybrid passive and actively powered upper torso augmentation system configured to augment the user's native strength by aiding movement of the user's arm through a desired range of motion. The upper torso augmentation system can include a body chassis, at least one arm assembly, a passive assist assembly, and an actively powered first and second adjustment mechanism. The body chassis can be configured to be worn around a torso of the user. The at least one arm assembly can be operably coupled to the body chassis and can be configured to pivot relative to the body chassis within the desired range of motion. The passive assist assembly can be operably coupled to the at least one arm assembly, and can be configured to utilize stored potential energy to provide a lifting force to the user's arm in order to augment the user's native strength in counteracting the effects of gravity. The actively powered first and second adjustment mechanisms can be configured to enable adjustment of an output of the passive assist assembly to approximate a determined minimum assist force required for the user to move their arm through the desired range of motion, thereby minimizing any excess torque produced by the upper torso augmentation system.

Embodiments of the present disclosure focus therapy on “high quality” limb movements by tracking patient deviations from preferred pathways and/or within at least a prioritized three-dimensional range of motion. In one embodiment the prioritized three-dimensional range of motion can be represented by a portion of a concave cone within a broader range of motion enabled by systems and methods of the present disclosure. In one embodiment, the user's torso can intersect the concave cone, with a vortex of the cone positioned proximal to the user's nose, and a substantially horizontal base of the cone positioned proximal to the user's torso and/or waist. In one embodiment, the position of the base can be adjusted to inhibit maneuvering of the user's limb below the adjusted base, or in a fixed plane, so as to ease the workload of the user during the performance of therapy and/or ADL. For example, in some embodiments, a lateral extension pivot of the shoulder assembly can be configured to enable three settings, corresponding to a low, medium and high vertical adjustment zone. The lateral extension pivot can be actively powered, or passively adjusted. In some embodiments, the higher vertical adjustment zones correspond to lower torque requirements.

One embodiment of the present disclosure provides an upper torso augmentation system configured to augment the user's native strength by aiding movement of the user's arm within at least a prioritized three-dimensional range of motion within a broader range of motion enabled by the system. The upper torso augmentation system can include a body chassis, and arm assembly, and one or more biasing elements. The body chassis can be configured to be worn around a torso of the user. The arm assembly can be operably coupled to the body chassis and can be configured to pivot relative to the body chassis. The one or more biasing elements can be operably coupled to the arm assembly, and can be configured to utilize stored potential energy to provide a lifting force to the user's arm in order to augment the user's native strength in at least partially counteracting effects of gravity within the bounds of a prioritized three-dimensional range of motion. The prioritized three-dimensional range of motion can be defined by a concave cone, a vortex of the concave cone being in proximity to the user's nose, and a base of the concave cone positioned substantially horizontally and in proximity to the user's torso. The base of the concave cone can be adjusted to inhibit maneuvering of the user's hand below the adjusted base.

Another embodiment of the present disclosure provides an intent activatable upper torso augmentation system configured to increase augmentation of the user's native strength in maneuvering the user's arm in a predefined direction based on cues from the user. The intent activatable upper torso augmentation system can include a body chassis, at least one arm assembly, and a processor. The body chassis can be configured to be worn around a torso of the user. The at least one arm assembly can be operably coupled to the body chassis and can be configured to pivot relative to the body chassis within a broad range of motion. The at least one arm assembly can include an assisting force mechanism configured to augment the user's native strength in maneuvering the user's arm within at least a prioritized three-dimensional range of motion within the broader range of motion. The processor can be configured to receive information from the user and provide variable augmentation instructions to the assisting force mechanism. The information received by the processor can include a position of the user's body such that movement of the user's body in a given direction is interpreted by the processor as an intent by the user to move their arm in a corresponding direction, and the variable augmentation instructions provided by the processor directed the assisting force mechanism to increase augmentation of the at least one arm assembly in the corresponding direction.

Embodiments of the present disclosure can include one or more sensing devices configured to sense a position or pathway of a user's arm during use. Embodiments of the present disclosure can include a replay mode wherein a preferred pathway for movement can be recorded, and the user's native muscle movements can be augmented solely along the preferred pathway in order to guide the user's limb along the preferred pathway. One embodiment of the present disclosure provides an upper torso augmentation system configured to record a path of motion of a user's arm and selectively augment the user's native strength in repeated motion of the user's arm along the recorded path of motion. The upper torso augmentation system can include a body chassis, at least one arm assembly, and a processor. The body chassis can be configured to be worn around a torso of the user. The at least one arm assembly can be operably coupled to the body chassis and can be configured to pivot relative to the body chassis within a broad range of motion. The at least one arm assembly can include an assisting force mechanism configured to augment the user's native strength in maneuvering the user's arm within at least a prioritized three-dimensional range of motion within the broader range of motion. The processor can be configured to receive and record positional information based on movement of the user's arm, and to selectively provide variable augmentation instructions to the cable assembly. The positional information can include a desired repeatable path of motion of the user's arm, and the variable augmentation instructions provided by the processor can direct the assisting force mechanism to increase augmentation of the at least one arm assembly to guide the user's arm along the desired repeatable path of motion.

Another embodiment of the present disclosure provides a closed-loop control system configured to augment the user's native strength by aiding movement of the user's arm. The closed-loop control system can include a body chassis, at least one arm assembly, and a processor. The body chassis can be configured to be worn around a torso of the user. The at least one arm assembly can be operably coupled to the shoulder assembly and can include an assisted force mechanism, wherein an output of the assisted force mechanism is adjustable via a first adjustment mechanism and a second adjustment mechanism. The processor can be configured to receive one or more clinical parameters of interest from one or more sensing devices to determine at least one of a user's strength profile and/or a level of compliance with a prescribed exercise, and to command adjustment of the first adjustment mechanism and/or second adjustment mechanism based on the determined strength profile and/or level of compliance, so as to optimize the output produced by at least one arm assembly.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting an upper torso augmentation system in accordance with an embodiment of the disclosure.

FIG. 2A-B a perspective views depicting a body chassis of an upper torso augmentation system in accordance with an embodiment of the disclosure.

FIG. 3A-B a perspective views depicting the shoulder assembly of an upper torso augmentation system in accordance with an embodiment of the disclosure.

FIG. 4A-B depict cutaway profile views of a shoulder assembly and upper arm assembly of an upper torso augmentation system in accordance with an embodiment of the disclosure.

FIG. 5A depicts a torque and/or force curve for required manipulation of the upper torso augmentation system through a desired range of motion.

FIG. 5B depicts a graphical representation of an assisted force required curve for manipulation of the upper torso augmentation system through a desired range of motion.

FIGS. 6A-B depict cutaway profile views of a shoulder assembly and upper arm assembly of an upper torso augmentation system in accordance with an embodiment of the disclosure, in which a first adjustment mechanism is utilized to adjust an assisted force mechanism.

FIG. 6C depicts a graphical representation of the effective manipulation of the first adjustment mechanism on an assisted force output.

FIGS. 7A-B depict cutaway profile views of a shoulder assembly and upper arm assembly of an upper torso augmentation system in accordance with an embodiment of the disclosure, in which a second adjustment mechanism is utilized to adjust an assisted force mechanism.

FIG. 7C depicts a graphical representation of the effective manipulation of the second adjustment mechanism on an assisted force output.

FIG. 8A depicts a method of optimizing an assisted output of an upper torso augmentation system.

FIG. 8B depicts a graphical representation of optimizing an assisted output of an upper torso augmentation system.

FIG. 9 depicts a cutaway profile view of a shoulder assembly, upper arm assembly, and lower arm assembly of an upper torso augmentation system in accordance with an embodiment of the disclosure.

FIG. 10 depicts a partial view of a lower arm assembly of an upper torso augmentation system in accordance with an embodiment of the disclosure.

FIGS. 11A-B are perspective views depicting an upper torso augmentation system in accordance with an embodiment of the disclosure.

FIG. 12 is a perspective view depicting an upper torso augmentation system including a hand support in accordance with an embodiment of the disclosure.

FIG. 13A is a front view depicting a user utilizing an upper torso augmentation system configured to prioritize augmentation of limb movement within a predefined three-dimensional range of motion, in accordance with an embodiment of the disclosure.

FIG. 13B is a profile view depicting a user utilizing the upper torso augmentation system of FIG. 13A.

FIG. 13C is a top view depicting a user utilizing the upper torso augmentation system of FIG. 13A.

FIG. 13D is a perspective view depicting a user utilizing the upper torso augmentation system of FIG. 13A.

FIG. 14 is a perspective view depicting a user utilizing an upper torso augmentation system configured to prioritize augmentation of limb movement within a predefined three-dimensional range of motion, in accordance with another embodiment of the disclosure.

FIG. 15 is a schematic view depicting an upper torso augmentation system including a plurality of sensing devices, in accordance with an embodiment of the disclosure.

FIG. 16 is a depiction of a flow of information from data sensed by one or more sensing devices, in accordance with an embodiment of the disclosure.

FIG. 17 is a perspective view depicting a low-profile, upper torso augmentation system in accordance with an embodiment of the disclosure.

FIG. 18A is a rear view depicting a low-profile, upper torso augmentation system in accordance with an embodiment of the disclosure, wherein a sleeve assembly is disconnected from a body chassis.

FIG. 18B is a rear view depicting the low-profile, upper torso augmentation system of FIG. 18A, wherein the sleeve assembly is operably coupled to the body chassis.

FIGS. 19A-B are front views depicting an upper torso passive augmentation system having one or more wearable artificial muscles in accordance with an embodiment of the disclosure.

FIGS. 20A-B are front views depicting an upper torso passive augmentation system having one or more artificial muscles in accordance with another embodiment of the disclosure.

FIGS. 21A-G depict various embodiments of upper torso passive augmentation systems in accordance with the disclosure.

FIG. 22A is a perspective view depicting an upper torso augmentation system depicted, in accordance with an embodiment of the disclosure.

FIG. 22B is a close-up plan view depicting the tension adjustment mechanism of FIG. 22A

While embodiments of the disclosure are amenable to various modifications and alternative forms, specifics thereof are shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure as defined by the appended claims.

### DETAILED DESCRIPTION

### I. Passive and Hybrid Upper Torso Augmentation System

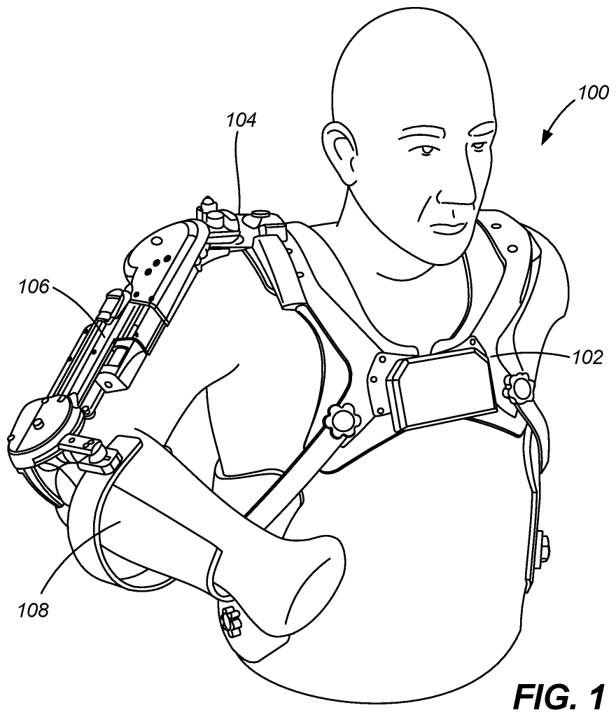

Referring to FIG. 1 an upper torso augmentation system 100 is depicted in accordance with an embodiment of the disclosure. The upper torso augmentation system 100 can be configured to assist a user in daily tasks and/or therapeutic treatments by using stored potential energy to decrease the force required to counteract gravity during maneuvering of a user's arm. As used herein, the term “user” and “patient” can be used interchangeably to refer to an individual with neuromuscular abnormalities, such as neuromuscular disorders, spinal injuries and limb impairment as a result of a stroke. In one embodiment, the upper torso augmentation system 100 can include a body chassis 102, a shoulder assembly 104, an upper arm assembly 106, and a lower arm assembly 108.

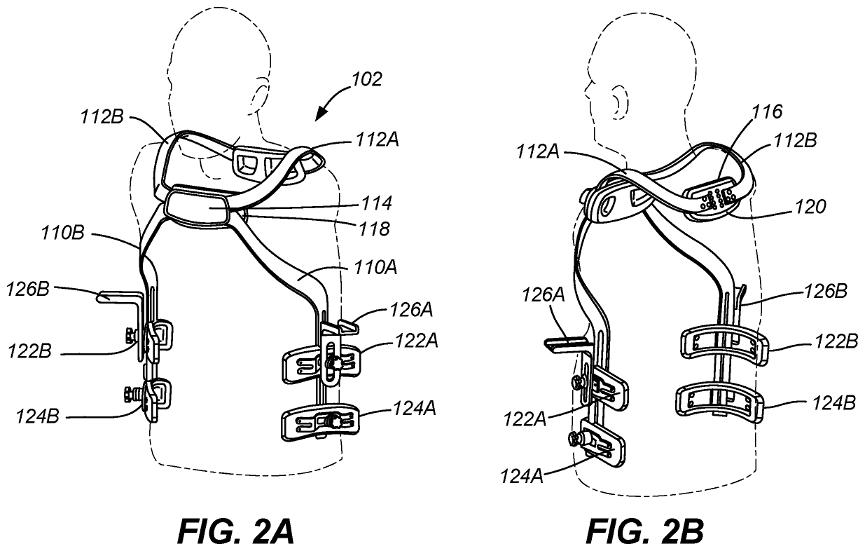

Referring to FIGS. 2A-B, front and rear perspective views of the body chassis 102 are depicted in accordance with an embodiment of the disclosure. In one embodiment, the body chassis 102 includes a plurality of rigid members working in concert with a plurality of breathable, stretchable, lightweight, and/or low friction fabrics, such as neoprene, 3-D printed nylon and other flexible polymers. The body chassis 102 can include a pair of lateral support members 110A, 110B, and a pair of shoulder support members 112A, 112B. The lateral support members 110A, 110B and shoulder support members 112A, 112B can be operably coupleable to an anterior hub 114. For example, in one embodiment, the lateral support and shoulder support members 110A-B, 112A-B are operably coupled to the anterior hub 114 via adjustable fasteners, such that the length and/or angle of the lateral support and shoulder support members 110A-B, 110B, 112A-B can be adjusted to accommodate different sized users. The shoulder support members 112A, 112B can further be coupled to one another via a posterior hub 116. Like the coupling to the anterior hub 114, the shoulder support members 112A, 112B can be operably coupled to the posterior hub 114 via adjustable fasteners, such that the length and/or angle of the shoulder support members 112A, 112B can be adjusted to accommodate different sized users.

In some embodiments, the body chassis 102 can be modular in nature, for example, in one embodiment, the lateral support members 110A, 110B and/or shoulder support members 112A, 112B can be easily interchanged for different sized and/or shaped lateral support members 110A, 110B and/or shoulder support members 112A, 112B in order to accommodate users of different sizes, ages and other physical characteristics. For improved comfort, the anterior hub 114 and posterior hub 116 can include respective torso cushioned pads 118, 120 configured to conform to the user's torso.

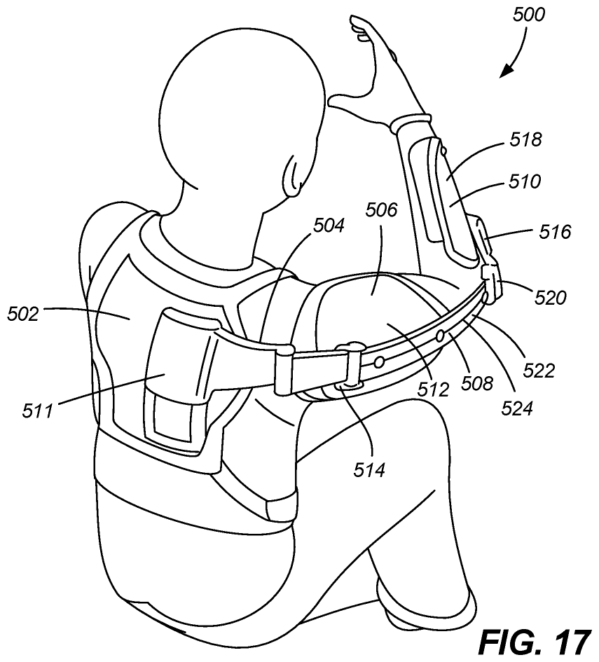

In another embodiment, body chassis 102 can comprise a wearable garment, such as a vest, to be worn around the body (e.g., shoulders and torso) of the user (as depicted in FIG. 17). For example, in one embodiment, the body chassis 102 can be constructed as a series of layers, with various levels of rigidity and support configured to suit the user's needs. In some embodiments, the body chassis 102 can be provided with positionable support panels with varying rigidities, so that the rigidity and/or support of portions of the body chassis 102 can be zoned as to accommodate movements of various degrees and extents. Accordingly, such embodiments enable the body chassis 102 to be modified in order to have the rigidity and/or flexibility as desired by the user.

With continued reference to FIGS. 2A-B, lateral support members 110 can include a plurality of lateral contacting pads 122A, 122B, 124A, and 124B, and one or more armchair supports 126A, 126B. The lateral contacting pads 122A, 122B, 124A, and 124B can be operably coupled to the lateral support members 110A, 110B via an adjustable fastener configured to enable ease in adjustment of the lateral contacting pads 122A-B, 124A-B relative to the respective lateral support members 110A, 110B. For example, in one embodiment, the lateral contacting pads 122A-B, 124A-B can be vertically adjusted up and down relative to a user's torso, as well as horizontally in and out relative to the user's torso so as to increase or decrease the distance between the lateral contacting pads 122A-B, 124A-B and the user's torso and/or pressure between the lateral contacting pads 122A-B, 124A-B and the user's torso. The lateral contacting pads 122A-B, 124A-B can also be configured to pivot laterally with respect to the user's torso for improved comfort and support. For improved comfort, the lateral contacting pads 122A-B, 124A-B can include respective cushioned contacts configured to conform to the user's torso.

In some embodiments, the torso cushioned pads 118, 120 and the lateral contacting pads 122A-B, 124A-B can be 3-D printed from a three-dimensional scan of the user's anatomy. In other embodiments, these portions can be vacuum thermoformed over a mold of the user or can be molded directly on the user with thermoformed heat limiting layered materials. In other embodiments, these portions can be conformable to the user through a combination of pressure and/or heat. Various combinations of these molding techniques are also contemplated.

The armchair supports 126A, 126B can be configured to provide supporting contact with the arms of a chair in which the user may be seated, thereby inhibiting the user from tipping and/or shifting laterally in the chair during use. In one embodiment, the armchair supports 126A, 126B can be operably coupled to the lateral support members 110A-B via respective lateral contacting pads 122A-B. In one embodiment, the armchair supports 126A-B can be vertically adjusted up and down relative to a user's torso, as well as horizontally in and out relative to the user's torso so as to adjust the distance between the armchair support 126A-B and the arms of the chair in which the user may be seated.

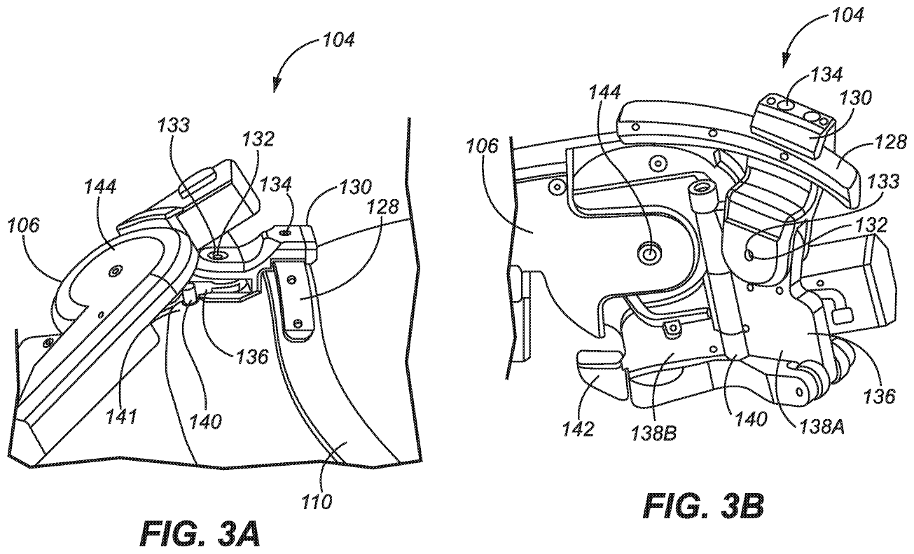

Referring to FIGS. 3A-B, perspective views of the shoulder assembly 104 are depicted in accordance with an embodiment of the disclosure. Shoulder assembly 104 can be configured to couple to the lateral support member 110. For example, in one embodiment, a rail 128 can be operably or fixedly coupled to the lateral support member 110. A shoulder coupling 130 can be slidably coupled to the rail 128, thereby enabling the shoulder assembly 104 (and upper and lower arm assemblies 106, 108) to be shiftably positioned relative to the body chassis 102. In some embodiments, the shoulder coupling 130 may be positioned on the rail 128 at the highest point on the shoulder of the user (depending on how the user may be positioned), so as to minimize the negative effects of gravity on a lateral pivot 132 of the shoulder assembly 104. In some embodiments, the shoulder coupling 130 can include a set screw 134 or other fastener configured to secure the shoulder coupling 130 in place relative to the rail 128.

In some embodiments, the shoulder coupling 130 is constructed of a rigid member having a proximal end configured to be coupled to the rail 128 and a distal end configured to be pivotably coupled to an adjustable upper arm coupling 136. The shoulder coupling 130 and the upper arm coupling 136 can be coupled via the lateral pivot 132, thereby enabling the upper arm coupling 136 to pivot relative to the shoulder coupling 130 and a generally horizontal orientation (i.e., substantially perpendicular to gravitational forces). In some embodiments, rotational movement about the lateral pivot 132 can be motorized via motor 133. In other embodiments, rotation about the lateral pivot 132 can be unassisted.

The shoulder coupling 130 can include a first portion 138A and a second portion 138B pivotably coupled to one another via a lateral extension pivot 140. In one embodiment, the first portion 138A can be pivotably coupled to the shoulder coupling 130 via the lateral pivot 132, and the second portion 138 can be pivotably coupled to the upper arm assembly 106 via a shoulder pivot 144. In some embodiments, the lateral extension pivot 140 can be adjusted to provide varying degrees of lateral extension of a user's arm during use of the upper torso augmentation system 100. Typically the lateral extension pivot 140 is not dynamically adjusted during use, but rather is adjusted prior to a therapeutic session so as to position the user's arm at a desired level. In some embodiments, the lateral extension pivot 140 can be configured to enable a user to position their arms between a position in close proximity to their torso (thereby enabling better control of arm movement, for example, near a tabletop or keyboard) and a position substantially level to the user's shoulders (thereby enabling better control of arm movement at a higher elevation, for example, near the user's face or head). In some embodiments, rotation about the lateral extension pivot 140 is motorized via motor 141. In other embodiments, rotation about the lateral extension pivot 140 is manually adjusted and locked into place. In one embodiment, a locking mechanism 142 enables a user to lock the lateral extension pivot 140 in a desired position.

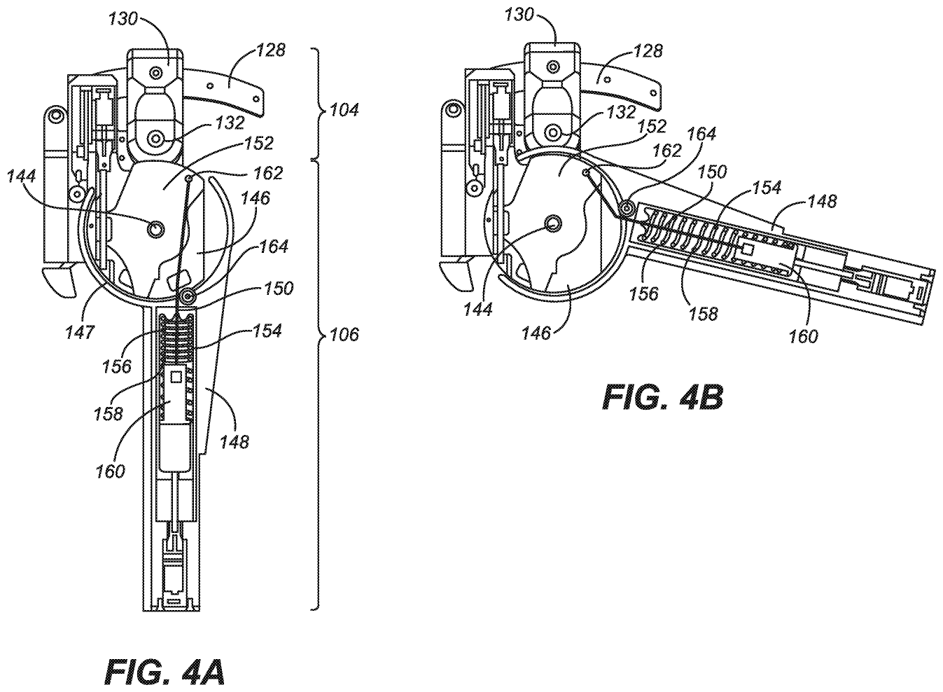

Referring to FIGS. 4A-B, cutaway profile views of the shoulder assembly 104 and upper arm assembly 106 are depicted in accordance with an embodiment of the disclosure. In one embodiment, the upper arm assembly 106 includes a shoulder pivot portion 146 pivotably coupled to a rigid upper arm member 148, thereby enabling portions of the upper arm assembly 106 to rotate relative to the shoulder assembly 104 via the shoulder pivot 144. In some embodiments, a bearing assembly 147 positioned between the shoulder pivot portion 146 and the upper arm member 148 can be configured to enable the upper arm member 148 to pivot relative to the shoulder pivot portion 146. Rotation about the shoulder pivot 144 is assisted via tension in a cable 150 running between a lever 152 operably coupled to the shoulder pivot portion 146 and a spring preload assembly 154 operably coupled to the upper arm member 148. In some embodiments, this is referred to as an assisting force mechanism. The cable 150 can traverse between the cable stop 160 and a coupling point 162 on the lever 152. In some embodiments, the cable 150 can traverse around a roller bearing 164 configured to enable the cable 150 to bend around a corner while under tension.

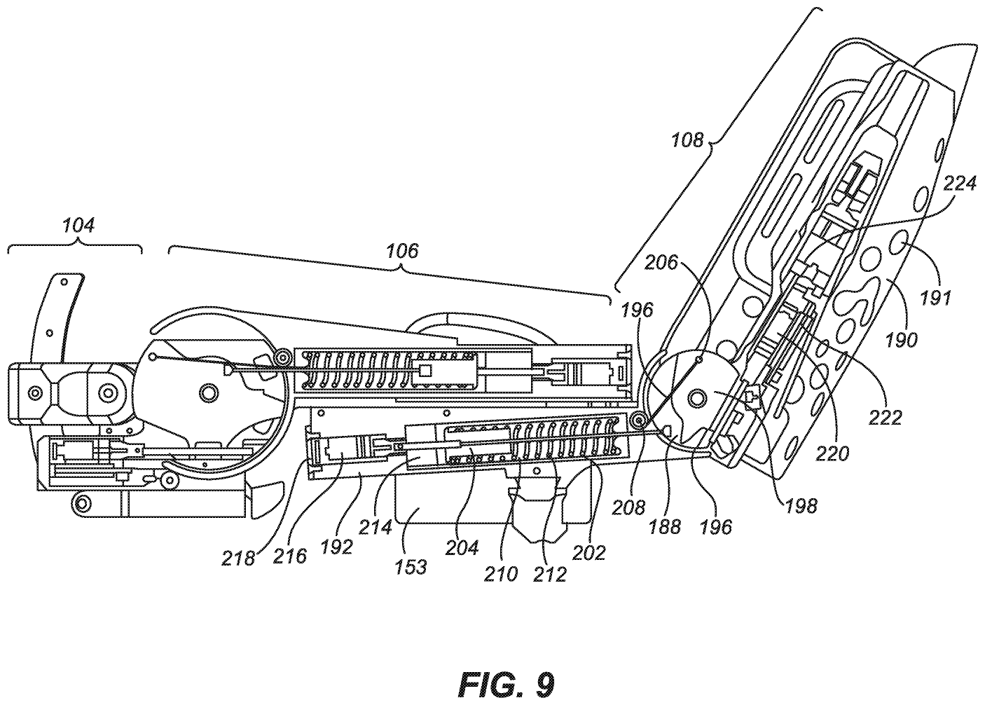

In one embodiment, the upper arm assembly 106 further includes an upper arm contact cuff 153 (as depicted in FIG. 9). In one embodiment, user skin contacting portions of the upper torso augmentation system 100, such as the upper arm cuff 153 can closely conform to the contours of the user. In one embodiment, these portions can be 3-D printed from a three-dimensional scan of the user's anatomy, vacuum thermoformed over a mold of the user or directly on the user with thermoformed heat limiting layered materials, conformable to the user through a combination of pressure and/or heat, or a combination thereof.

In one embodiment, the shiftable spring preload assembly 154 includes a shuttle 156, a biasing element 158, and a cable stop 160. In one embodiment, the biasing element 158 can be a compression spring, such that the biasing element 158 communicates a tensile force to cable 150, so as to urge the upper arm member 148 to rotate with respect to the shoulder pivot portion 146 within a desired range of motion. The range of motion can, for example range between a position of the upper arm member 148 in which the user's arm is substantially vertically downward oriented (referred to as an upper arm angle of 0°) (as depicted in FIG. 4A) and a position of the upper arm member 148 in which the user's arm is substantially horizontally oriented (referred to as an upper arm angle of 90°). FIG. 4B depicts the upper arm member 148 at an upper arm angle of approximately 75°. Other ranges of motion, for example between upper arm angles of −15° and 185° are also contemplated.

Accordingly, in one embodiment, the upper torso augmentation system 100 utilizes stored potential energy biasing element 158 to store potential energy to aid the user in raising, lowering and maneuvering their arms to overcome the effects of gravity. Thus, the system 100 can be considered passive, in that it does not give the user added strength, but merely reduces the force required by the user to overcome the effects of gravity, to augment the native strength of the user. In one embodiment, the anti-gravitational assist force created by the upper torso augmentation system 100 matches the torque of the arm due to gravity, thereby effectively canceling the effect of gravity.

The torque required of the upper torso augmentation system 100 can be computed, for example, by multiplying the mass of the user's arm and applicable portions of the upper torso augmentation system 100 by the lateral distance between the user's shoulder (i.e. the axis of rotation) in the center of mass of the user's arm, wherein the lateral distance is substantially perpendicular to the Earth's gravitational force. Accordingly, the torque of the arm can follow a sinusoidal relationship with the angle of the arm, such that little to no torque is required when the user's arm is substantially vertical, and a maximum amount torque is required when the user's arm is substantially perpendicular to the Earth's gravitational force.

Depending on the needs of the user, the degree to which the upper torso augmentation system 100 counteracts the effects of gravity can be adjusted. In one embodiment, the upper torso augmentation system 100 can be configured to provide a small lifting force, for example, a fraction of the weight of the user's arm. In other embodiments, the upper torso augmentation system 100 can provide a lifting force substantially equal to the weight of the user's arm. In yet other embodiments, the upper torso augmentation system 100 can provide a lifting force substantially equal to the weight of the user's arm plus an object for which the user wishes to lift.

The required tension of the biasing element 158 can be computed to provide the desired effect. In one embodiment, the requirements of biasing element 158 can be computed according to the following formula:

Mg=k Y

wherein M is the mass to be supported, g is the acceleration due to gravity, k is the spring constant, and Y is the distance that the elastic member 158 and/or 188 is stretched.

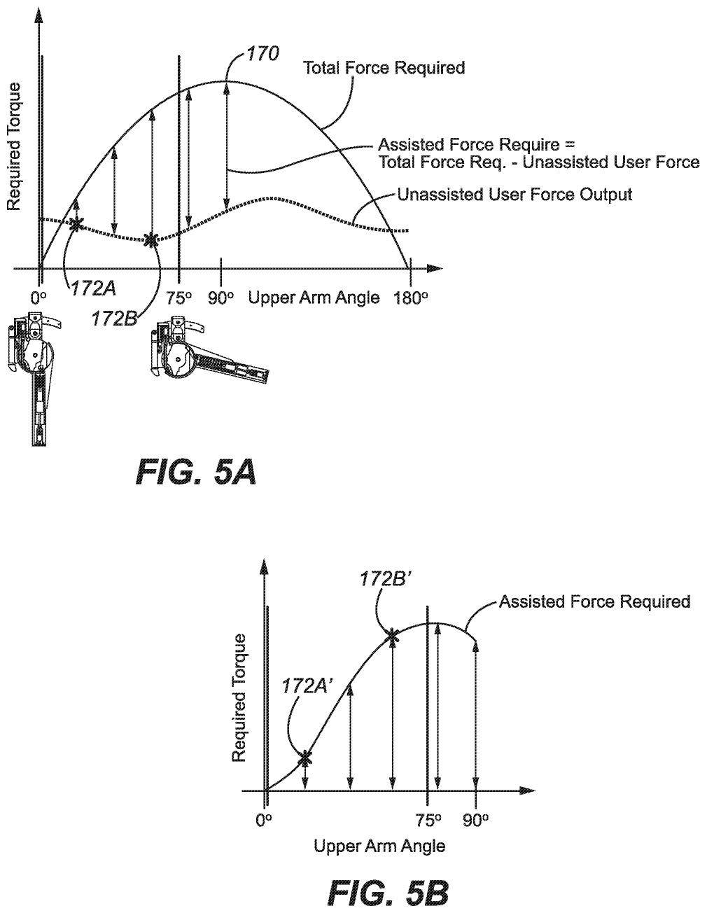

Referring to FIG. 5A, a graphical representation of the torque requirements across a desired range of motion is depicted in accordance with an embodiment of the disclosure. In this embodiment, the desired range of motion is plotted between an upper arm angle of between 0° and 180°. As depicted, the Total Force requirement to lift both the user's arm and a portion of the upper torso augmentation system 100 is generally represented by a parabola, or one half of the sinewave, in which the peak torque requirement 170 is centered on the upper arm angle of approximately 90°.

In order to determine the level of assistance required by the upper torso augmentation system 100 (i.e., the Assisted Force requirement), in some embodiments, an Unassisted Force output of the user can be measured across the desired range of motion. In some embodiments, one or more Unassisted Force output data points 172A-B can be collected along the desired range of motion. The measured Unassisted Force output can then be subtracted from a determined Total Force to determine the Assisted Force requirement. FIG. 5B depicts the plot of the determined Assisted Force requirement over an abridged desired range of motion. In some embodiments, one or more Assisted Force requirement data points 172A-B′ can be determined along the desired range of motion.

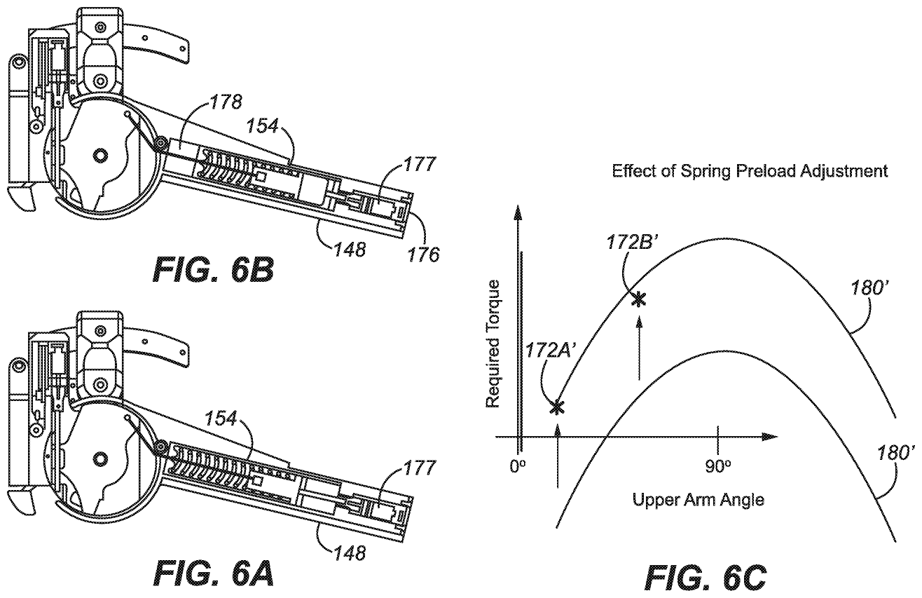

Referring to FIGS. 6A-B, in some embodiments, it is possible to shift the spring preload assembly 154 relative to the upper arm member 148 in order to affect the Assisted Force output of the upper torso augmentation system 100. In some embodiments, this is referred to as a first adjustment mechanism. For example, in one embodiment, the upper arm member may include a channel 178 in which the spring preload assembly 154 is configured to shift. In pure passive systems, shifting of the spring preload assembly 154 may be performed manually, for example by a set screw or threaded carrier assembly. In highbred systems, shifting of the preload assembly 154 can be performed via an actuator 174 and related control circuitry 176. Accordingly, in some embodiments, the spring preload assembly 154 can be variably shifted between a first position, in which the spring preload assembly 154 is shifted closer to the shoulder pivot portion 146 (as depicted in FIG. 6A) and a second position, in which the spring preload assembly 154 is shifted further away from the shoulder pivot portion 146 (as depicted in FIG. 6B). In some embodiments, shifting of the preload assembly 154 from the first position to the second position increases the tension in the biasing element 158 and/or cable 150.

As depicted in FIG. 6C, in some embodiments, shifting of the spring preload assembly 154 from the first position to the second position has the effect of increasing the torque provided by the upper arm assembly 106 across the force curve. As represented graphically, shifting of the spring preload assembly 154 from the first position to the second position has the effect of shifting the assistance force parabola vertically upward (i.e., from a first assisted force output 180 to a second assisted force output 180′).

In some embodiments, the assisted force output 180 of the upper arm assembly 106 can be increased so as to encompass the one or more determined assisted force requirement data points 172A-B′. In cases where multiple assisted force requirement data points 172A-B′ are present, increasing the assisted force output 180 to ensure that all data points 172A-B′ fall within the area of the assisted force output 180′, can result in an excess of assisted force over certain portions of the desired range of motion. For example, as depicted in FIG. 6C, shifting the assisted force output 180′ to match the data point 172A′ results in an excess amount of torque proximal to data point 172B′. As it is believed that the patient generally receives the greatest beneficial therapeutic effect through the exercise and use of their own strength, and excess torque output by the upper torso augmentation system 100 (which reduces the degree to which the patient must utilize their own strength) is undesirable.

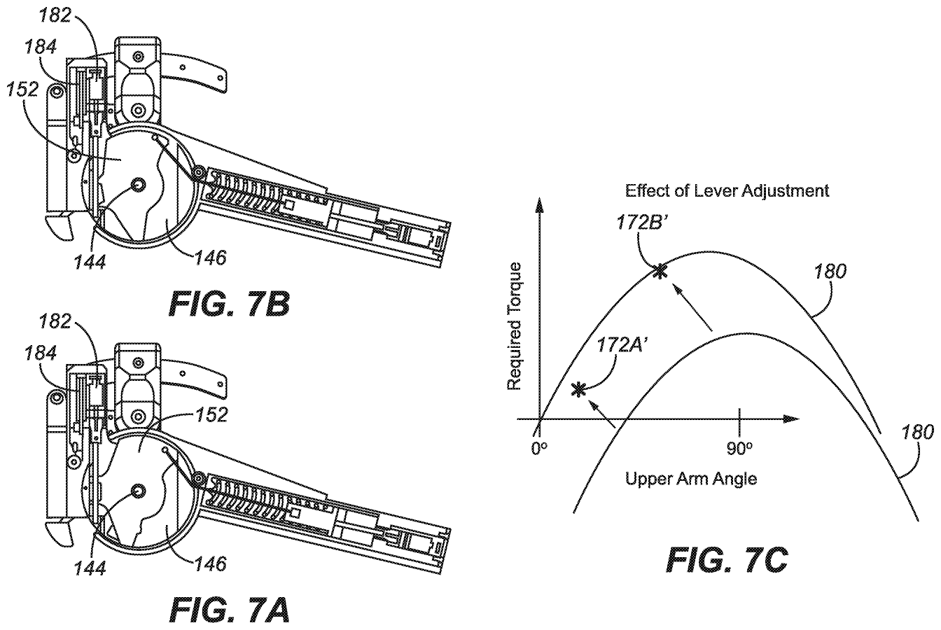

Referring to FIGS. 7A-B, in some embodiments, it is possible to rotate the lever 152 relative to the shoulder pivot portion 146 in order to affect the Assisted Force output of the upper torso augmentation system 100. In some embodiments, this is referred to as a second adjustment mechanism. For example, in one embodiment, the lever 152 can pivot about the shoulder pivot 144, thereby increasing the tension in the cable 150 to varying degrees over the desired range of motion. In pure passive systems, rotation of the lever 154 may be performed manually, for example by a set screw or threaded carrier assembly. In highbred systems, rotation of the lever 154 may be performed via an actuator 182 and related control circuitry 184. Accordingly, in some embodiments, the lever 152 can be variably shifted between a first position (as depicted in FIG. 7A), and a second position, in which the lever 152 is shifted counterclockwise (as depicted in FIG. 7B). Shifting of the lever 152 in a clockwise manner in order to increase tension in the cable 150 in varying degrees over the desired range of motion is also contemplated.

As depicted in FIG. 7C, in some embodiments, rotation of the lever 150 from the first position to the second position has the effect of shifting the torque profile provided by the upper arm assembly 106 across the force curve. As represented graphically, rotation of the lever 150 from the first position to the second position has the effect of shifting the assistance force parabola both vertically upward and to the left (i.e., from a first assisted force output 180 to a second assisted force output 180′).

In some embodiments, the assisted force output 180 of the upper arm assembly 106 can be increased so as to encompass the one or more determined assisted force requirement data points 172A-B′. In cases where multiple assisted force requirement data points 172A-B′ are present, increasing the assisted force output 180 to ensure that all data points 172A-B′ fall within the area of the assisted force output 180′ can result in an excess of assisted force over certain portions of the desired range of motion. For example, as depicted in FIG. 7C, shifting the assisted force output 180′ to match the data point 172B′ results in an excess amount of torque proximal to data point 172A′.

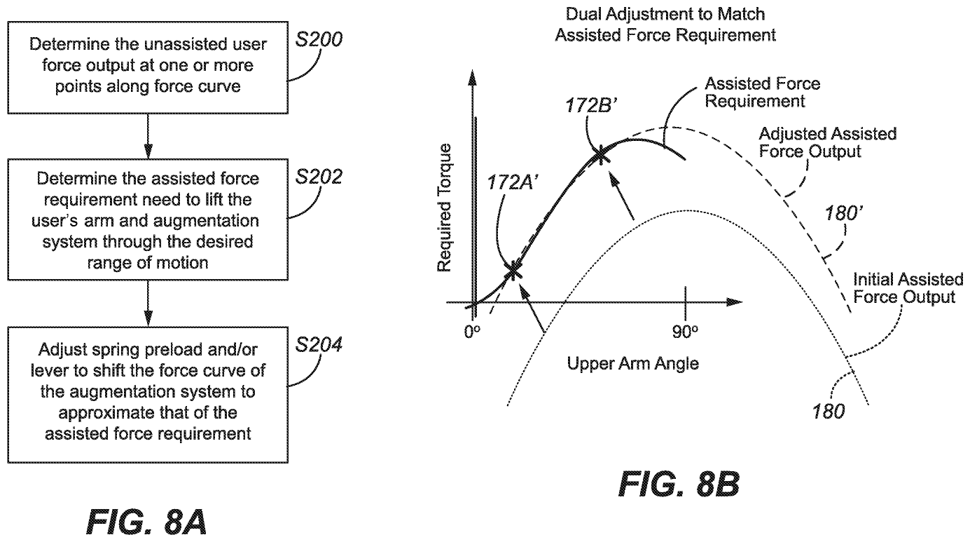

Referring to FIG. 8A, in one embodiment, a method of optimizing the assisted force output 180 of the upper torso augmentation system 100 is depicted in accordance with an embodiment of the disclosure. At S200, an Unassisted Force output of a user can be measured across the desired range of motion. For example, in some embodiments, one or more Unassisted Force output data points 172A-B can be collected along the desired range of motion. In some embodiments, this step may be performed prior to the user donning the upper torso augmentation system 100. In other embodiments, this step may be combined with the other method steps and performed while wearing the upper torso augmentation system 100.

At S202, the Assisted Force requirement needed to lift both the user's arm and portions of the augmentation system 100 through the desired range of motion can be determined. In one embodiment, a Total Force requirement to lift both the user's arm and the upper torso augmentation system 100 is determined based on a known weight of portions of the upper torso augmentation system 100 and an estimated or actual weight of the user's arm (potentially including the weight of any articles of clothing and/or jewelry). In another embodiment, the Total Force requirement is determined based at least partially on video analysis. The measured Unassisted Force output is then be subtracted from a Total Force requirement to determine the Assisted Force requirement. In some embodiments, one or more Assisted Force requirement data points 172A-B′ can be determined along the desired range of motion.

At S204, the spring preload assembly 154 is shifted and/or the lever 152 is rotated until the assisted force output 180 of the upper torso augmentation system 100 approximates the Assisted Force requirement, thereby minimizing any excess amount of torque produced by the upper torso augmentation system 100, and maximizing the Unassisted Force requirements, thereby improving the quality of the therapy.

In some embodiments, the various method steps can be performed dynamically, in concert with one another during movement through the desired range of motion. For example, a user can be directed to raise their arm until a portion of either the upper arm assembly 106 and/or lower arm assembly 108 reaches a first upper arm angle corresponding to a first data point (e.g., 172A). If the user is unable to reach the first upper arm angle, the spring preload assembly 154 can be shifted and/or the lever 152 can be rotated to provide an additional Assistance Force. Upon reaching the first upper arm angle, a first assistance force provided by the upper torso augmentation system 100 can be determined. The determined assistance force can then be subtracted from the Total Force requirement to determine a first unassisted force provided by the user. These steps can be repeated for additional upper arm angles/data points, until an Unassisted Force output curve can be determined from the collected data points. The measured Unassisted Force output can be subtracted from a Total Force requirement to determine the Assisted Force requirement.

As depicted in FIG. 8B, the spring preload assembly 154 can be shifted and/or the lever 152 can be rotated until the assisted force output 180 of the upper torso augmentation system 100 approximates the Assisted Force requirement, thereby minimizing any excess amount of torque produced by the upper torso augmentation system 100. In some embodiments, the above described steps can be utilized for optimizing the assisted force output 180 of both the upper arm assembly 106 and the lower arm assembly 108. In some embodiments, optimization of the assisted force output 180 of the upper and lower arm assemblies 106/108 can be performed independently or simultaneously.

Referring to FIG. 9, a cutaway profile view of the shoulder assembly 104, upper arm assembly 106, and lower arm assembly 108 is depicted in accordance with an embodiment of the disclosure. In some embodiments, the lower arm assembly 108 can have a similar structure to the upper arm assembly 106, with the exception being that certain components of the lower arm assembly 108 can be smaller than the upper arm assembly 106.

In one embodiment, the lower arm assembly 108 includes an elbow pivot portion 188 fixedly coupled to a lower arm cuff 190, and pivotably coupled to a rigid lower arm member 192, thereby enabling portions of the lower arm assembly 108 to rotate relative to the upper arm assembly 106 via an elbow pivot 194. In one embodiment, the lower arm cuff 190 can closely conform to the contours of the user, and can include one or more apertures 191 to increase ventilation and/or decrease the weight of the lower arm cuff 190. In one embodiment, this portion can be 3-D printed from a three-dimensional scan of the user's anatomy, vacuum thermoformed over a mold of the user or directly on the user with thermoformed heat limiting layered materials, conformable to the user through a combination of pressure and/or heat, or a combination thereof.

In some embodiments, a bearing assembly 196 positioned between the elbow pivot portion 188 and the lower arm member 192 can be configured to enable the lower arm cuff 190 to pivot relative to the rigid lower arm member 192. Rotation about the elbow pivot 194 is assisted via tension in a cable 196 running between a lever 198 operably coupled to the elbow pivot portion 188, and a spring preload assembly 202 operably coupled to the lower arm member 192. The cable 196 can traverse between a cable stop 204 and a coupling point 206 on the lever 198. In some embodiments, the cable 196 can traverse around a roller bearing 208 configured to enable the cable 196 to bend around the corner while under tension.

In one embodiment, the shiftable spring preload assembly 202 can include a shuttle 210, a biasing element 212, and a cable stop 204. In one embodiment, the biasing element can be a compression spring, such that the biasing element 212 communicates a tensile force to the cable 196, so as to urge the lower arm cuff 190 to rotate with respect to the lower arm member 192 with any desired range of motion. In some embodiments, this can be referred to as a lower arm assisting force mechanism. The range of motion can, for example, range between a position of the upper lower arm cuff 190 in which the user's lower arm is substantially aligned with the user's upper arm, and a position of the lower arm cuff 190 in which the user's lower arm is angled 90° or more relative to the user's upper arm. Other ranges of motion are also contemplated.

Accordingly, in one embodiment, the lower arm assembly 108 utilizes stored potential energy within a biasing element 212 to store potential energy to aid the user in raising, lowering, and maneuvering their lower arm to overcome the effects of gravity. Thus, the system can be considered passive, in that it does not give the user added strength, but merely reduces the force required by the user to overcome the effects of gravity to augment the native strength of the user. In one embodiment, the anti-gravitational assist force created by the lower arm assembly 108 attempts to match the torque of the arm due to gravity, thereby effectively canceling the effect of gravity.

Like the upper arm assembly 106, in some embodiments, it is possible to shift the spring preload assembly 202 relative to the lower arm member 192 in order to affect the Assisted Force output of the upper torso augmentation system 100. For example, in one embodiment, the lower arm member 192 can include a channel 214 in which the spring preload assembly 202 is configured to shift. In pure passive systems, shifting of the spring preload assembly 202 can be performed manually, for example, by a set screw or threaded carrier assembly. In hybrid systems, shifting of the preload assembly 202 can be performed via an actuator 216 and related control circuitry 218. Accordingly, in some embodiments, the spring preload assembly 202 can be variably shifted between a first position, in which the spring preload assembly 202 is shifted closer to the elbow pivot portion 188 (as depicted in FIG. 9) and a second position, in which the spring preload assembly 202 is shifted further away from the elbow pivot portion 188. In some embodiments, this is referred to as a first adjustment mechanism. In some embodiments, shifting of the preload assembly 202 from the first position to the second position, or anywhere between the first and second position, causes the cable 196 tension to increase.

In some embodiments, it is possible to rotate the lever 198 relative to the elbow pivot portion 188 in order to affect the Assisted Force output of the upper torso augmentation system 100. For example, in one embodiment, the lever 198 can pivot about elbow pivot 194, thereby increasing the tension in the cable to varying degrees over the desired range of motion. In some embodiments, this is referred to as a second adjustment mechanism. In pure passive systems, rotation of the lever 198 can be performed manually, for example by a set screw or threaded carrier assembly. In hybrid systems, rotation of the lever 198 can be performed via an actuator 220 and related circuitry 222. Accordingly, in some embodiments, the lever 198 can be shifted between a first position (as depicted in FIG. 9), and a second position, in which the lever is shifted clockwise. Shifting of the lever 198 in a counterclockwise manner in order to increase tension in the cable in varying degrees over the desired range of motion is also contemplated. Dynamic adjustment of the Assisted Force output of the lower arm assembly 108 can be performed substantially in the same manner as the upper arm assembly 106.

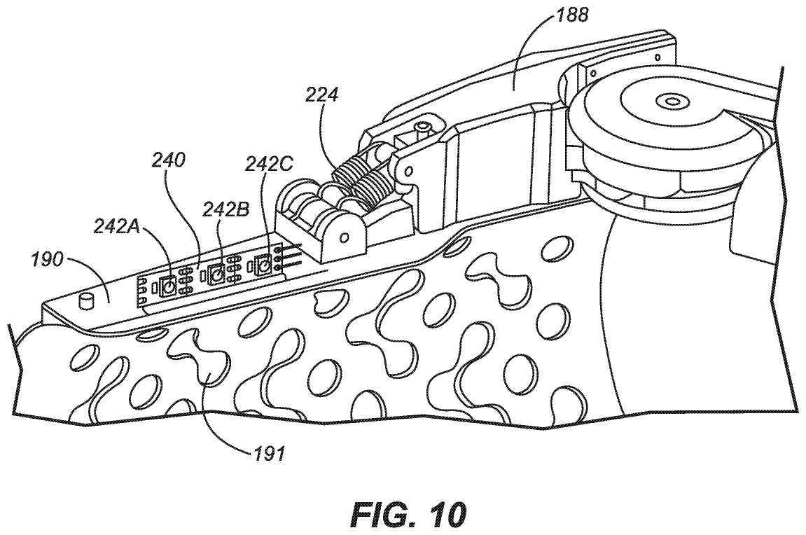

In one embodiment, the lower arm cuff 190 can be operably coupled to the elbow pivot portion 188 via a spring assembly 224. As depicted in FIG. 10, the spring assembly 224 can be configured to enable the user to manipulate their lower arm with slight deviations from the lower arm assembly 108. For example, in one embodiment, the spring assembly 224 can be configured to provide a small degree of play (e.g., up to 5° of movement in any given direction) in the connection between the elbow pivot portion 188 and the lower arm cuff 190. Accordingly, the spring assembly 224 can be configured to improve comfort and reduce the possibility of an overextension of the user's lower arm during use.

As further depicted in FIG. 10, in one embodiment, the upper torso augmentation system 100 can include an indicator panel 240 including one or more indicators 242A-C. In one embodiment, the one or more indicators can be single or multi-colored LEDs configured to provide feedback to the user via use modes, data gathering, and functionality.

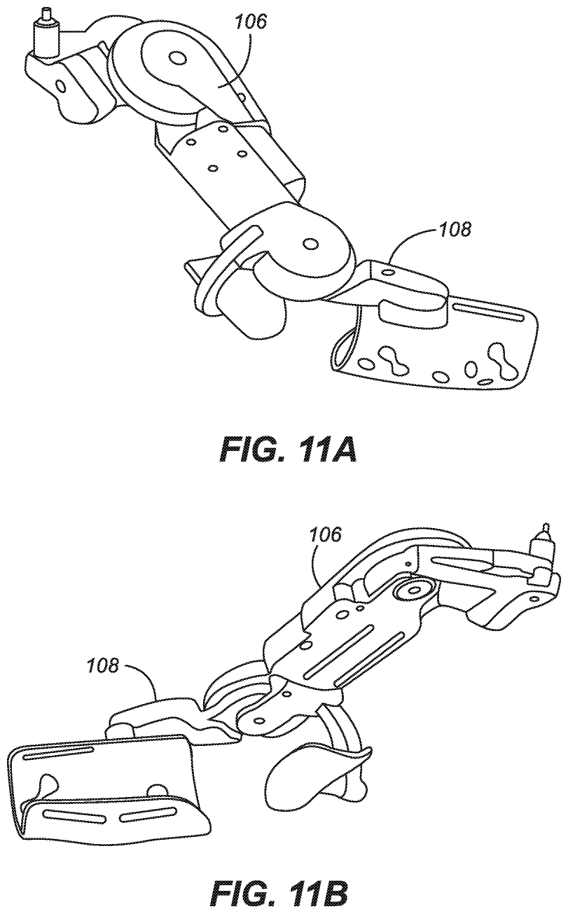

Referring to FIGS. 11A-B, additional perspective views of portions of the upper torso augmentation system 100 are depicted in accordance with an embodiment of the disclosure. As depicted, assisting force mechanisms of the respective upper and lower arm assemblies 106/108 can be covered by protective shrouds. In some embodiments, the upper torso augmentation system 100 is entirely passive, and does not include any actuators for manipulation of the assisting force mechanisms. Rather, the assisting force mechanisms are adjusted manually.

In other embodiments, the upper torso augmentation system 100 is a hybrid system in which the assisting force mechanisms are dynamically adjusted and/or manipulated by first and second adjustment mechanisms including electric actuators. In these embodiments, the actuators indirectly affect the Assisted Force output of the upper torso augmentation system 100 by changing the mechanical advantage of the assisting force mechanisms and/or the tension in the cables associated with the assisting force mechanisms. Utilizing an actively powered assist assembly to adjust the output of a passive system, rather than directly providing an active lifting force reduces weight and bulk of the components (e.g., lighter weight actuators may be utilized), and significantly reduces battery consumption, enabling the use of a smaller, lighter weight battery and/or power source.

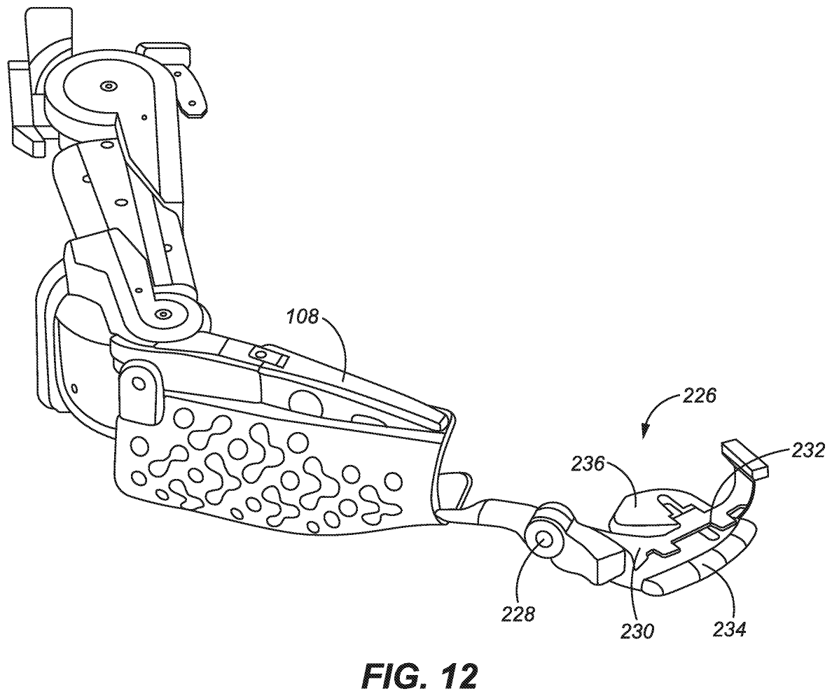

Referring to FIG. 12, in one embodiment, the upper torso augmentation system 100 can further include a hand support 226 operably coupled to the lower arm assembly 108. The hand support 226 can include a pivot 228, which can be configured to enable adjustment of the angle of the hand support 226 relative to the lower arm assembly 108. The hand support 226 can further include a hand cradle 230. In one embodiment, the hand cradle 230 can include a bridge 232, a forward support 234 and a rear support 236. In one embodiment, the forward and rear supports 234, 236 can be operably coupled to the bridge 232 via a biasing element configured to enable the forward and rear supports 234, 236 to flex and pivot relative to the bridge 232.

A. Modularity

In one embodiment, the upper torso augmentation system 100 is modular in nature, such that various components of the upper torso augmentation system 100 can be removed and/or replaced with different sizes and/or shapes of components to accommodate users of different sizes, ages, weights, and other physical characteristics. Depending upon the user's needs, portions of the upper torso augmentation system 100 can be removed. For example, certain users may only require the upper arm assembly 106 to meet their desired level of augmentation. Thus, the upper torso augmentation system 100 can be constructed using just the body chassis 102, shoulder assembly 104 and upper arm assembly 106. Accordingly, the modularity of the upper torso augmentation system 100 enables the device 100 to be fitted to users of varying sizes, and enables the device 100 to be modified to accommodate growth in child users.

In one embodiment, one or more of the pivotable couplings can be quick disconnect couplings, thereby enabling the various components of the orthotic device 100 to be disassembled and/or separated without the use of tools. For example, in one embodiment, the shoulder assembly 104 can be uncoupled from the body chassis 102, and optionally coupled to another fixture, such as a chair, wheelchair or bed.

The upper torso augmentation system 100 can fit closely to the user, in a low-profile manner. The upper torso augmentation system 100 can be constructed of lightweight, high-strength fabrics, plastics and metals to reduce bulk and minimize discomfort, thereby promoting wearability of the augmentation system 100 for long periods of time. Moreover, through the augmentation system's 100 various linkages, plates, and pivotal connections, the movement of the orthotic device closely approximates that of the user's arm, thereby enabling a broad array of Range of Motion (ROM) activities. In one embodiment, the range of motion can include wrist extension, wrist flexion, lower arm pronation, lower arm supination, elbow flexion, upper arm elevation, upper arm rotation, and/or shoulder rotation.

B. Prioritized Ranges of Motion

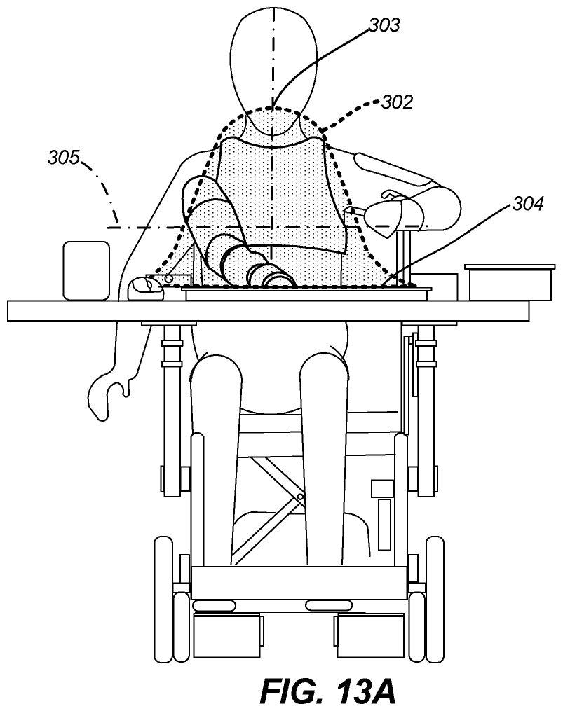

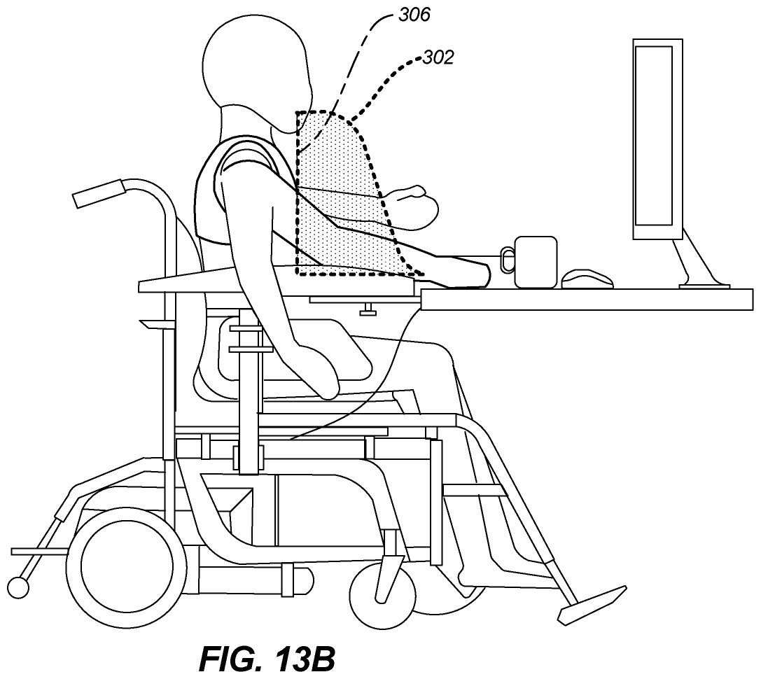

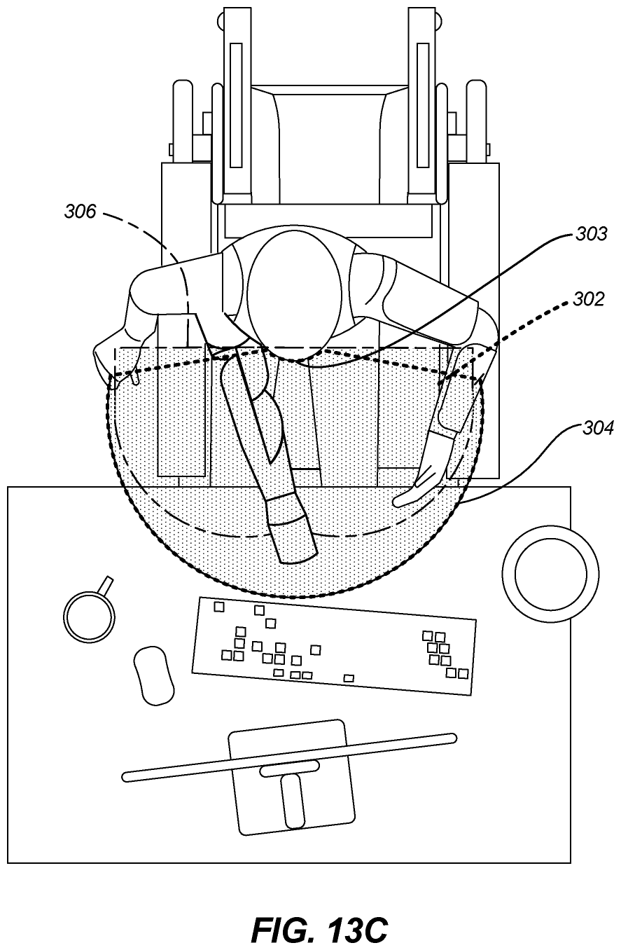

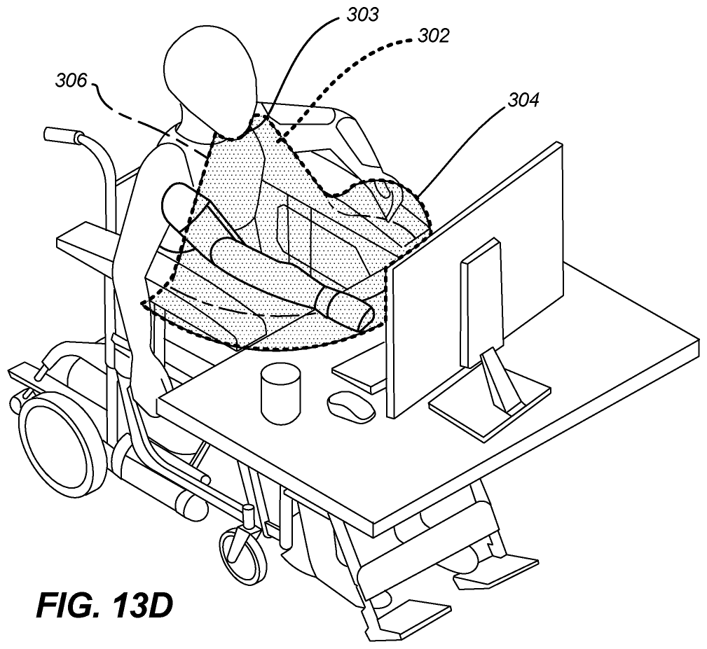

Referring to FIGS. 13A-D and 14, high frequency of use and/or prioritized three-dimensional zones configured to enable desired ranges of motion for a user utilizing the upper torso augmentation system 100 are depicted in accordance with an embodiment of the disclosure. In one embodiment, the upper torso augmentation system 100 can be configured to focus on “high-quality” upper torso augmentation by prioritizing limb movement within a predefined three-dimensional range of motion. In one embodiment, the three-dimensional range of motion can be shaped and sized to enable the user to maneuver their upper limbs, including their hands within an anterior three-dimensional envelope enabling many therapeutic and ADL functions. That is, although movements of the user's limb can extend outside of the predefined three-dimensional range of motion when using the upper torso augmentation system, augmentation of the limb movements can be prioritized within the predefined three-dimensional range of motion, thereby providing greater assistance, better control, and/or a higher degree of fidelity to limb movements within the three-dimensional range of motion.

The anterior three-dimensional envelope can have an average width of at least the width of the user's shoulders, wherein the width broadens towards a bottom of the envelope and narrows towards a top of the envelope. The envelope can have a height extending between the user's waist, lap, and/or tabletop and a portion of the user's face, for example the user's mouth. The envelope can have a depth extending between the user's hand, when the user's upper limb is extended in the anterior direction, and the user's torso, wherein the depth broadens towards the bottom of the envelope and narrows towards the top of the envelope.

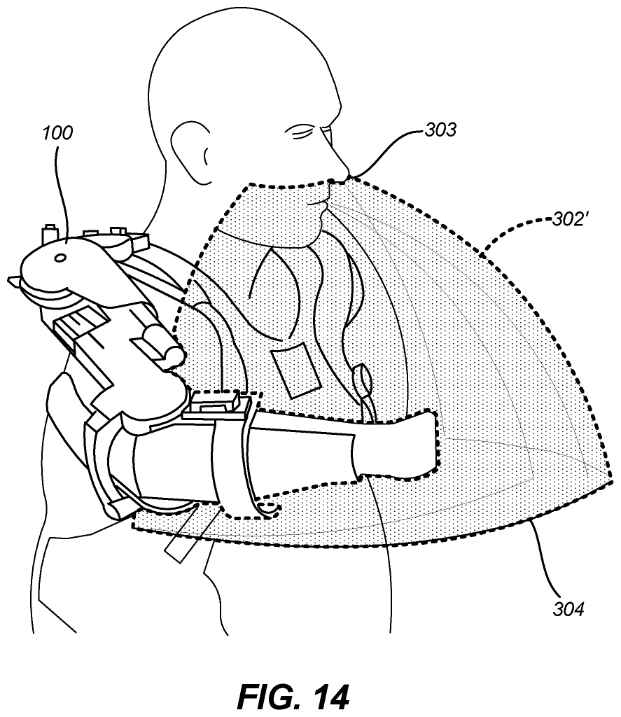

As depicted in FIG. 13A-D, in one embodiment, the predefined three-dimensional range of motion can be approximated by a concave cone 302. As depicted in FIG. 14, in other embodiments, the predefined three-dimensional range of motion can be approximated by a convex cone 302′. A vortex 303 of the cone 302 can be positioned proximal to the user's head and/or face, for example the user's nose. A base 304 of the cone 302 can be substantially parallel to the horizontal plane 305, and can be positioned proximal to, for example, the abdomen of the user. As depicted in FIG. 13B, the cone 302 can be intersected by a substantially vertical plane 306 positioned proximal to the user's torso.

In one embodiment, the base 304 of cone 302 can be vertically adjusted up and down, as desired. In one embodiment, movement of the upper torso augmentation system 100 can be constrained horizontally, so to enable the user to move their arms above the base 304, but not below the base 304. In some embodiments, the height of base 304 can be vertically adjusted via the lateral extension pivot 140 of the shoulder assembly 104, such that the lateral extension pivot 140 is locked into place, while other pivots (e.g., the lateral pivot 132) are free to rotate, thereby establishing a fixed plane in which the upper torso augmentation system 100 can operate. For example, in one embodiment, the lateral extension pivot 140 can be adjusted to enable a user to position their arms between a position in close proximity to their torso and a position substantially level to the user's shoulders. In one embodiment, the lateral extension pivot 140 can be configured to lock between 0-90° in 15° increments. In some embodiments, the lateral extension pivot 140 can be limited to three settings (e.g., 0°, 45° and 60°), corresponding to a low, medium and high vertical adjustment zone. The lateral extension pivot 140 can be actively powered, or passively adjusted. In some embodiments, the higher vertical adjustment zones correspond to lower torque requirements.

In some cases, constraining movement at or above a fixed plane, can enable the user to perform certain motions for a longer time, without the added fatigue of maintaining a horizontal position of their upper limbs against the effect of gravity. In one embodiment, the augmented movements within the prioritize three-dimensional envelope can include wrist extension, wrist flexion, lower arm pronation, lower arm supination, elbow flexion, upper arm elevation, upper arm rotation, and/or shoulder rotation. In some embodiments, the fixed plane need not be horizontal or aligned with the base 304 as depicted in FIGS. 13A-D.

C. Incorporation of Sensors and Associated Functionality

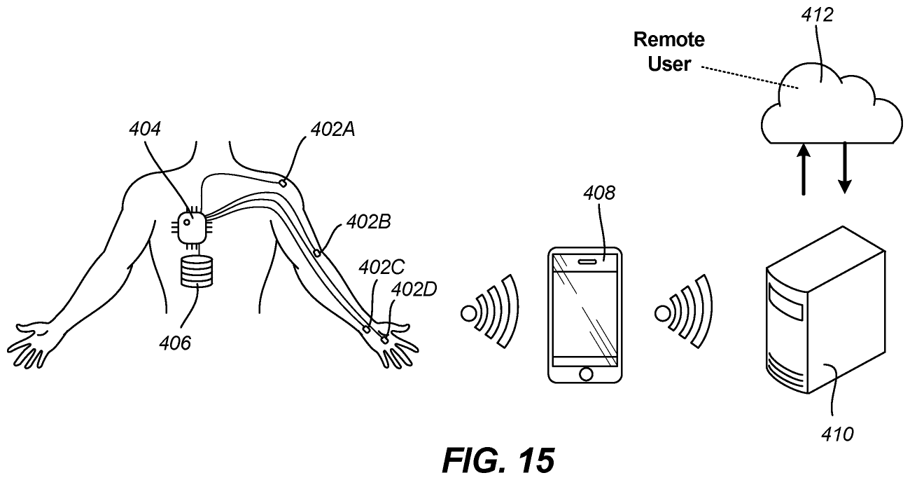

Referring to FIG. 15, embodiments of the upper torso augmentation system 100 can include a plurality of sensing devices 402A-D configured to monitor one or more clinical parameters of interest during use. For example, the sensing devices can include inertial measurement unit (IMU) sensors, EMG sensors, or body motion sensors, such as accelerometers, angle sensors, and/or flex sensors. The plurality of sensing devices 402 can sense, for example, a position (e.g., pronation and/or supination of extremities), a continuous or sequence of tracked positions over a period of time, a range of motion of a user, dates and times of particular events, a total time of augmented activity, training, or rehabilitation, as well as other conditions of the user, such as a physiological strength profile, heart rate, electrical activity of the heart, and perspiration. In one embodiment, the upper torso augmentation system can further include one or more sensing devices configured to sense a user condition. For example, the sensing device can include heart rate sensors, peripheral capillary oxygen saturation (SpO2) sensors, EKG electrodes, temperature sensors, and/or humidity sensors. In one embodiment, the sensing devices are positioned within or proximal to portions of the body chassis 102, shoulder assembly 104, upper arm assembly 106, and/or lower arm assembly 108. In another embodiment, the sensing devices are positioned on or within a separate garment that is worn as an independent layer, underneath or overtop of these components.

In some embodiments, data sensed by the plurality of sensing devices 402 is communicated to a processor 404. Processor 404 can optionally store the sensed data to a memory 406. Sensed data collected by the processor 404 can be transmitted to one or more computing devices 408. In one embodiment, the computing device 408 can be a mobile computing device and/or a cellular telephone. The processor 404 can transmit the sensed data to the computing device 408 through either a wired connection or wirelessly.

The sensed data can be summarized and displayed on the computing device 408, thereby providing feedback to the user regarding their performance and/or use of the augmentation systems. For example, in one embodiment, the information can be utilized in a closed-loop control system configured to optimize a torque output produced by the upper torso augmentation system 100, or graded as part of a CIMT process. In one embodiment, predefined activity and/or motion goals can be set, such that information from the plurality of sensing devices can be used to indicate when the predefined goal has been achieved. In one embodiment, the processor 404 can be in continuous communication with the computing device 408, thereby providing a streaming source of feedback to the user. For example, in one embodiment, the computing device 408 can provide feedback regarding one or more physical therapy goals set by a clinician, such as a rehabilitation specialist. In other embodiments, the computing device 408 can remind the user that it is time to perform certain exercises of their ambulatory rehabilitation regimen.

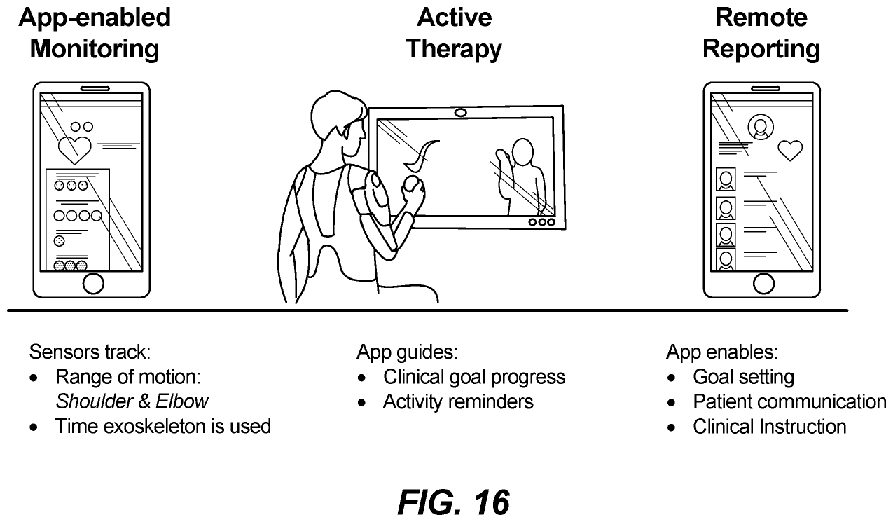

Information from the computing device 408 relating to the sensed data can be transmitted to one or more servers 410. In one embodiment, the computing device 408 can transmit the information to the server 410 through either a wired connection or wirelessly. The server 410 can be in communication with a data cloud 412 in which the information derived from the sensing devices 402 can be collected, analyzed and shared with others, including remote users. Accordingly, clinicians can check up on their patients remotely to determine if particular goals have been met, and if the patient is following their prescribed rehabilitation regimen. As depicted in FIG. 16, based on this information, a clinician can redefine goals for the patient, communicate information, such as reminders to a patient, and/or provide other instruction beneficial to the patient.

In one embodiment, a clinician can select one or more exercises and/or assessments from a battery of training aids for the patient to perform on a scheduled basis. In one embodiment, the training aids can be in the form of a video. Thereafter, the patient can be reminded by the computing device 408 that it is time to perform their exercises. The computing device 408 can then sense when the user is ready to perform the exercise, and, when appropriate, play the training aid of the prescri

bed exercise for the user. While the user is performing the exercise, the computing device 408, in addition to tracking data via sensing devices 402, can record video of the user performing the exercise. The sensed data from the sensing devices 402 along with the video of the user performing the exercise, can then be reviewed by the clinician.

In one embodiment, sensing devices 402 can be configured to sense when the user is shaking, for example, as a result of fatigue. In hybrid embodiments, active power elements can be in communication with processor 404, such that the powered elements can be dynamically adjusted to compensate for the increased fatigue. For example, in one embodiment, the forces on the biasing elements can be increased to further augment the user's native muscles. In one embodiment, the powered elements, based on inputs from processor 404, serve to counteract the shaking of the user, for the purpose of enabling the user to steady their hand while performing certain tasks.

In one embodiment, the active power elements can receive direction from processor 404 to augment particular desired body motion amplification based on instructions from the user. For example, in one embodiment, one or more sensing devices 402 can be positioned in the body chassis and can be configured to detect movement of the user's head and/or neck. Movement of the head and/or neck by the user, which can be in combination with pressure applied to the upper or lower arm assemblies by the user's native muscles, can be interpreted as an intent to perform an action, such as moving the user's arm up or down, or to the left or right. For example, the user tilting their head forward can be interpreted as an indication that the user intends to raise their arms in order to see the object in their hands more closely, or to place food into their mouth. The user moving their head back to the prone position can be interpreted as an indication that the user intends to lower their arms. Similarly, the user either rotating or tilting their head to the right can be interpreted as an indication that the user intends to bring their right arm closer to their face. Again, the user moving their head back to the prone position can be interpreted as an indication that the user intends to return their arm to the earlier position. In other embodiments, intent activated augmentation variability can be affected by muscle force along the desired body motion track, control via a joystick or straw, eye tracking, or verbal control, for example via computing device 408.

In one embodiment, the active power elements can be operably coupled to a closed-loop control system configured to continuously receive updates from the one or more sensing devices 402 as to the position of the user's arm. For example, in one embodiment, the processor can be configured to receive one or more clinical parameters of interest from the one or more sensing devices 402 to determine at least one of a user's strength profile and/or a level of compliance with a prescribed exercise, and to command adjustment of the first adjustment mechanism and/or second adjustment mechanism based on the determined strength profile and/or level of compliance, so as to optimize a torque output produced by the upper torso augmentation system. In one embodiment, the closed-loop control systems can be particularly effective in treating conditions involving spasticity, or in other cases where unintentional (and often rapid) muscle activity causes the user's arm to deviate from a desired motion.

In one embodiment, a user can utilize the computing device 408 to track and record a particular motion. For example, the motion can be to turn the page on a book. Thereafter, based on the user's command and/or the interpreted intent of the user, the active power elements can receive direction from processor 404 to provide augmentation to guide the user's arm along the same track, thereby enabling the user to repeat a particular motion numerous times without the normal amount of fatigue that would accompany such repetitive motion.

In one embodiment, portions of the cuffs and/or body chassis can include power elements configured to apply pressure to the skin of the user. In one embodiment, based on the user's heart rate and/or EKG information, the active power elements can be employed to promote circulation in certain parts of the user's body. Accordingly, in some embodiments, portions of the upper torso augmentation systems can perform a peristaltic massaging function.

### II. Low-Profile Upper Torso Augmentation

Referring to FIG. 17, another embodiment of a low-profile, upper torso augmentation system 500 is depicted in accordance with the disclosure. Like other disclosed embodiments, the upper torso augmentation system 500 can be configured to assist a user in daily tasks and/or therapeutic treatment to decrease the force required to at least counteract the effects of gravity when maneuvering of the user's arm.

In one embodiment, the upper torso augmentation system 500 can include a body chassis 502, shoulder assembly 504, an upper arm assembly 506, and a lower arm assembly 510. The body chassis 502 can be constructed as a vest configured to fit over a portion of the torso of the user. In one embodiment, the body chassis 502 can include a support panel 511.

The shoulder assembly 504 can include one or more shoulder hinge plates pivotably coupled to one another. As depicted in FIG. 17, the shoulder assembly 504 includes two shoulder hinge plates; however, other shoulder assembly 504 configurations are also contemplated.

The upper arm assembly 506 can include an upper arm linkage 508 and upper arm cuff 512. The upper arm linkage 508 can be constructed of a rigid material and can be pivotably coupled to the distal end 514 of the shoulder assembly 504. The upper arm cuff 512 can be configured to support and/or couple to a portion of the user's upper arm. In one embodiment, the upper arm linkage 508 can be integrally molded within the upper arm cuff 512.

The lower arm assembly 510 can include a lower arm linkage 516 and a lower arm cuff 518. The lower arm linkage 516 can be constructed of a rigid material and can be pivotably coupled to a portion of the upper arm linkage 508. In one embodiment, the lower arm linkage 516 can be coupled to the upper arm linkage 508 via an elbow assembly 520. The elbow assembly 520 can enable the lower arm linkage 516 to pivot relative to the upper arm linkage 508 about at least one axis of rotation. In other embodiments, the lower arm assembly 510 can be at least partially free-floating relative to the upper arm assembly 506, so as to rely on the user's elbow as the pivot mechanism. The lower arm cuff 518 can be configured to support and/or coupled to a portion of the user's lower arm. The lower arm assembly 510 can further include a hand wrap (not depicted) configured to support and/or coupled to a portion of the user's hand.

In another embodiment, the upper torso augmentation system 500 can include one or more resilient member 524. The elastic member 524 can be operably coupled between at least one of the body chassis 502 and/or the shoulder assembly 504 and at least one of the upper arm linkage 508 and/or the lower arm linkage 516. The elastic member 524 can be configured to store potential energy to assist a user in the augmentation of their native strength in the maneuvering of their arm, for the purpose of at least partially counteracting the effects of gravity. In one embodiment, use of passive elements within a hybrid power source can reduce the energy requirements during active augmentation, thereby enabling ambulatory systems to run longer on a given battery source.

In one embodiment, user skin contacting portions of the upper torso augmentation system 500, such as the body chassis 502, the upper arm cuff 512 and the lower arm cuff 518 can closely conform to the contours of the user. In one embodiment, these portions can be 3-D printed from a three-dimensional scan of the user's anatomy, vacuum thermoformed over a mold of the user or directly on the user with thermoformed heat limiting layered materials, conformable to the user through a combination of pressure and/or heat, or a combination thereof.

Like earlier disclosed embodiments, the upper torso augmentation system 500 is modular in nature, such that the various components thereof can be interconnected to other components of varying shapes and sizes, in order to accommodate users of different sizes, ages and other physical characteristics. Likewise, in one embodiment, the lower arm assembly 510 can be removed if it is not needed by the user.

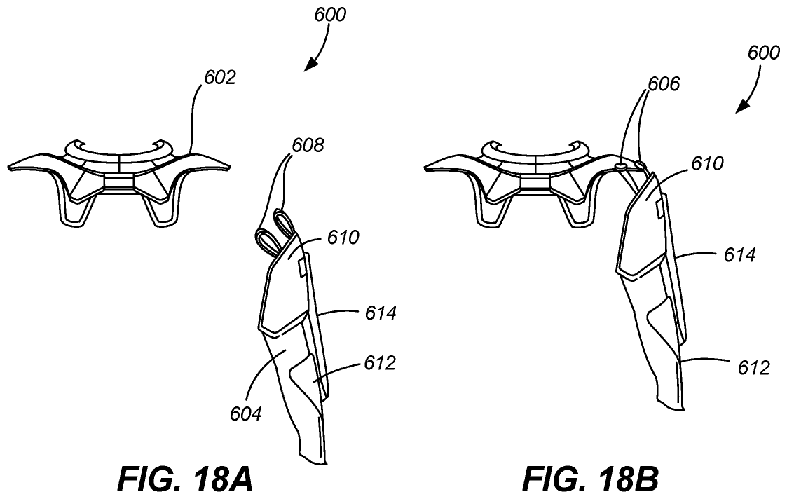

Referring to FIGS. 18A-B, another embodiment of a low-profile, upper torso augmentation system 600 is depicted in accordance with the disclosure. Like other disclosed embodiments, the upper torso augmentation system 600 can be configured to assist a user in daily tasks and/or therapeutic treatment to decrease the force required to counteract the effects of gravity when maneuvering of the user's arm.

In one embodiment, the upper torso augmentation system 600 can include a body chassis 602 and one or more sleeve assembly 604. In one embodiment, the body chassis 602 can be smaller than other disclosed body chassis and that it can be worn primarily around the neck and shoulders of a user, rather than around the chest of the user. In other aspects, the body chassis 602 can be of similar construction to other disclosed embodiments. In one embodiment, the body chassis 602 can include one or more sleeve connections 606.

The sleeve assembly 604 can be constructed of a breathable, stretchable, lightweight and/or low friction fabric configured to conform to the arm of a user. In one embodiment, a user can don the sleeve assembly 604 by slipping their arm through a tubular portion of the sleeve. The sleeve 604 can include one or more body chassis connections 608. The one or more body chassis connections 608 can be selectively coupled to the one or more sleeve connections 606, thereby operably coupling the body chassis 602 to the sleeve assembly 604. In one embodiment, the sleeve and/or body chassis connections 606, 608 can be flexible to enable the sleeve assembly 604 to shift and pivot relative to the body chassis 602. In one embodiment, the sleeve and/or body chassis connection 606, 608 can be positioned to inhibit movement of the sleeve assembly 604 relative to the body chassis 602 beyond certain predefined angles and/or extensions.

In one embodiment, the sleeve assembly 604 can include an upper arm cuff 610 and a lower arm cuff 612. Upper and lower arm cuffs 610, 612 can be constructed of a semi-rigid material, and can be configured to provide rigid support to the sleeve assembly 604. In one embodiment, one or more elastic members 614 can operably coupled the upper arm cuff 610 to the lower arm cuff 612. The elastic member 612 can be configured to store potential energy to assist a user in the augmentation of their native strength to maneuvering their arm, for the purpose of at least partially counteracting the effects of gravity.

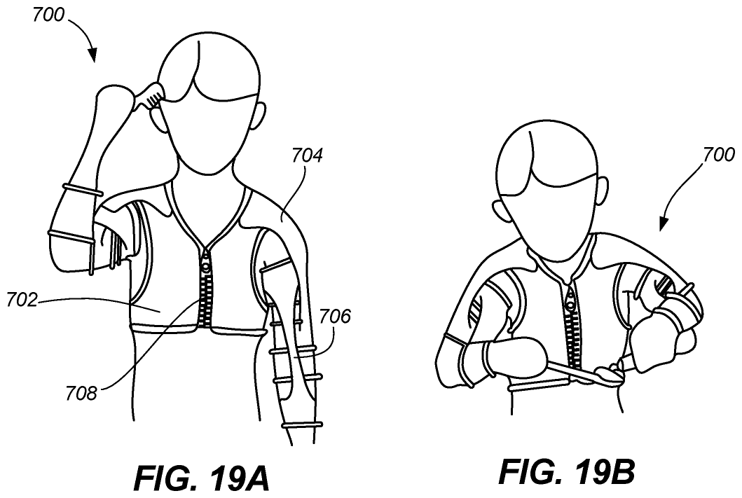

Referring to FIGS. 19A-21G, embodiments of upper torso passive augmentation systems are depicted in accordance with the disclosure. Like other disclosed embodiments, the upper torso augmentation systems 700 can be configured to assist a user in daily tasks and/or therapeutic treatments to decrease the force required to counteract the effects of gravity when maneuvering of the user's arm.

In one embodiment, the upper torso augmentation system 700 can be constructed as a wearable garment. For example, in one embodiment, the upper torso augmentation system 700 can include a vest and/or jacket portion 702 configured to be worn around a torso of the user. Various other components configured to augment the native strength of certain muscle groups can be added to the vest and/or jacket portion 702 as needed.

For example, as depicted in FIG. 19A-B, one embodiment of the upper torso augmentation system 700 can include a deltoid augmentation mechanism 704, and a bicep augmentation mechanism 706. The deltoid and bicep augmentation mechanisms 704, 706 can be comprised of one or more elastomeric bands configured to stretch to enable a user a full range of motion, while providing resiliency to augment the user's native strength in the maneuvering of their arm and counteracting the effects of gravity.

In one embodiment, a first portion of the deltoid augmentation mechanism 704 can be operably coupled to the vest portion 702. A second portion of the deltoid augmentation mechanism 704 can be configured to operably couple to a portion of the user's upper arm, for example, proximal to their elbow. Elastomeric material between the first portion and the second portion can be configured to augment the user's deltoid muscle group in movement of the user's arm.

The bicep augmentation mechanism 706 can include a first portion configured to operably couple to a portion of the user's upper arm, for example, above the second portion of the deltoid augmentation mechanism 704. A second portion of the bicep augmentation mechanism 706 can be configured to operably couple to a portion of the user's lower arm, for example, proximal to the wrist of the user. Elastomeric material between the first portion and the second portion can be configured to augment the user's bicep muscle group in movement of the user's arm.

In one embodiment, the vest portion 702 can include a zipper 708 for easily donning and doffing the upper torso augmentation system 700. The deltoid and bicep augmentation mechanisms 704, 706 can be selectively coupleable to the vest portion 702, for example, by a hook and loop fastener assembly (commonly referred to as VELCRO). In one embodiment, the second portion of the deltoid assembly and the first and second portions of the bicep assembly can form cuffs configured to wrap around portions of the user's arm and selectively couple to itself to maintain a firm grip around the user's arm. In one embodiment, the cuffs can include a hook and loop fastener assembly to enable the user to adjust the pressure and/or grip of the cuffs. In one embodiment, the deltoid and bicep augmentation mechanisms 702, 704 can be easily replaced with other augmentation mechanisms having the appropriate elasticity for optimization of upper torso augmentation 700.

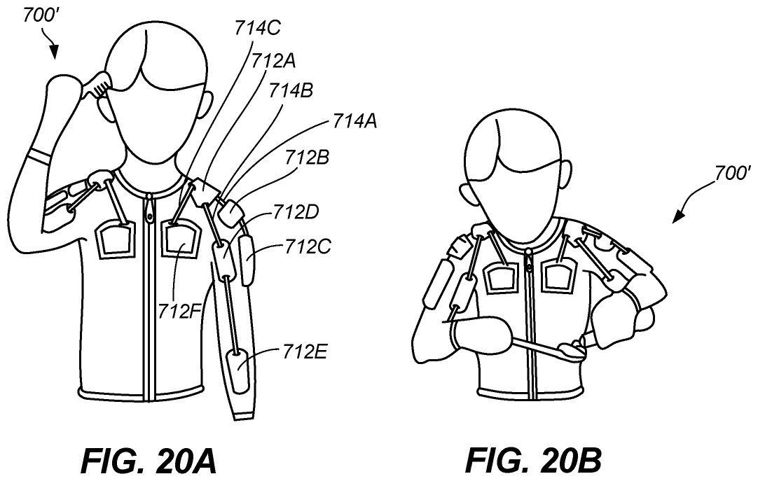

Referring to FIGS. 20A-B, other embodiments of the upper torso augmentation system 700′ can include a plurality of pads 712A-F operably coupled to the jacket portion 702. In one embodiment, the plurality of pads 712A-F can be fixedly coupled to the jacket portion 702, for example, via stitching and/or adhesive. In other embodiments, the plurality of pads 712A-F are selectively coupled to the jacket portion 702, for example, via a hook and loop fastener assembly, thereby enabling the pads 712A-F to be easily relocated.

In one embodiment, one or more elastic members 714A-C can be operably coupled the plurality of pads 712A-F. In one embodiment, the one or more elastic members 714A-C can be configured to provide resiliency to augment the user's native strength in the maneuvering of their arm and counteracting the effects of gravity.

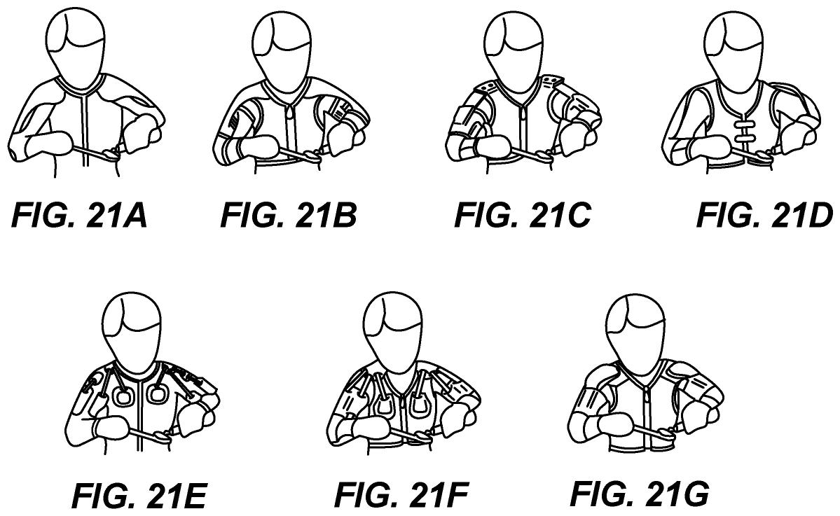

FIGS. 21A-21G depict various other exemplary embodiments of the upper torso augmentation system 700, including a wearable shirt having molded elastomeric bands (depicted in FIG. 21A), a wearable vest having molded elastomeric bands (depicted in FIG. 21B), a wearable vest having one or more leaf springs (depicted in FIG. 21C), a wearable vest having one or more elastic members configured to aid in rotation of the user's arm (depicted in FIG. 21D), a wearable shirt having one or more elastic members and/or cables (depicted in FIG. 21E), a wearable vest having one or more elastic cables or straps (depicted in FIG. 21F), and a wearable vest having one or more torsion springs (depicted in FIG. 21G).

### III. Linkage Based Augmentation System

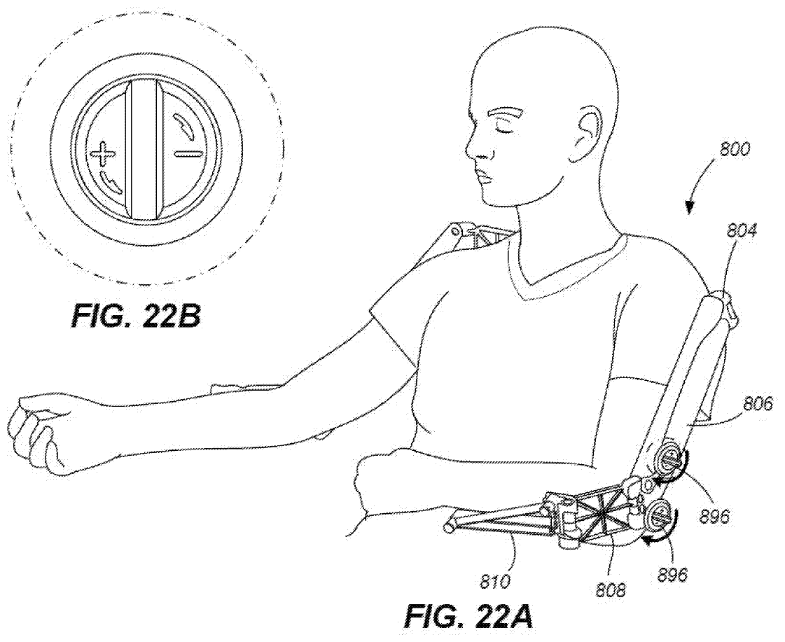

Referring to FIG. 22 an upper torso augmentation system 800 is depicted in accordance with another embodiment of the disclosure. In this embodiment, one or more of the pins 862, 894 coupling elastic member 858 to an upper arm assembly can be replaced by a tension adjustment mechanism 896. A close-up of the tension adjustment mechanism 896 is depicted in FIG. 22B. In one embodiment, tension adjustment mechanism 896 can include an eccentric cam, the rotation of which can increase or decrease the length of, and in turn the tension of, elastic member 858.

Accordingly, with a given biasing element 858 having a spring constant k, varying masses can be compensated for by the adjustment of pins 862 and/or the adjustment of tension adjustment mechanism 896, thereby changing the distance Y. In other embodiments, the spring constant k can be varied by changing the elastic member 858 and/or 888 and/or adding one or more additional elastic members.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not and/or 188 directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

1. An upper torso augmentation system configured to augment a native strength of an arm of a user by aiding movement of the arm, the upper torso augmentation system comprising:
a body chassis configured to be worn around a torso of the user;
a shoulder assembly pivotably coupled to the body chassis; and
an upper arm assembly pivotably coupled to the shoulder assembly, the upper arm assembly including a hybrid assisting force mechanism that provides an additional force to aid movement of the arm, wherein the additional force of the hybrid assisting force mechanism is adjustable via an actuator and related control circuitry, thereby enabling the additional force to approximate a determined minimum assist force required to move the arm through a desired range of motion.

2. The upper torso augmentation system of claim 1, wherein the assisting force mechanism includes a biasing element configured to rotate a rigid member about a pivot.

3. The upper torso augmentation system of claim 2, wherein the biasing element is a compression spring.

4. The upper torso augmentation system of claim 2, wherein the actuator and related control circuitry shifts the biasing element relative to at least one of the rigid member and/or the pivot.

5. The upper torso augmentation system of claim 4, wherein the hybrid assisting force mechanism comprises a shiftable preload assembly, in which the biasing element is housed in a shuttle shiftable within a channel defined in the rigid member.

6. The upper torso augmentation system of claim 2, wherein the assisted force mechanism further includes a cable traversing between the biasing element and a coupling point.

7. (canceled)

8. (canceled)

9. The upper torso augmentation system of claim 1, further comprising a lower arm assembly pivotably coupled to the upper arm assembly.

10. The upper torso augmentation system of claim 9, wherein lower arm assembly includes a lower arm assisted force mechanism in which an output is adjustable through a desired range of motion.

11. An upper torso augmentation system configured to augment a native strength of an arm of a user by aiding movement of the arm, the upper torso augmentation system comprising:
a body chassis configured to be worn around a torso of the user;
a shoulder assembly pivotably coupled to the body chassis; and
an upper arm assembly pivotably coupled to the shoulder assembly, the upper arm assembly including a hybrid assisting force mechanism that provides an additional force to aid movement of the arm, wherein the additional force of the hybrid assisting force mechanism is produced by a passively powered biasing element, and the passively powered biasing element is adjustable via a actively powered adjustment mechanism, thereby enabling the additional force to approximate a determined minimum assist force required to move the arm through a desired range of motion.

12. A method of optimizing an additional force of an upper torso augmentation system configured to augment a native strength of an arm of a user by aiding movement of the arm through a desired range of motion, the method comprising:
determining the native strength of the arm at one or more points along the desired range of motion;
determining a minimum assist force requirement necessary to move the arm and portions of the upper torso augmentation system through the desired range of motion; and
adjusting a hybrid assisting force mechanism via an actuator and related control circuitry to tailor the additional force of the upper torso augmentation system to approximate the determined minimum assist force requirement.

13. The method of claim 12, wherein determining the native strength involves measuring a maximum force that a user is able to generate when pivoting at least one of their upper arm about their shoulder and/or their forearm about their elbow.

14. The method of claim 12, wherein determining a minimum assisted force requirement is computed by subtracting the determined native strength from a total force requirement to move both the arm and a portion of the upper torso augmentation system through the desired range of motion.

15. The method of claim 14, wherein the total force requirement is a sum of the native strength and an assistance force generated by the upper torso augmentation system sufficient to enable movement of the arm and a portion of the upper torso augmentation system through the desired range of motion.

16. The method of claim 14, wherein the total force requirement is determined based on a known weight of the upper torso augmentation system and at least one of an estimated or actual weight of the arm.

17. The method of claim 14, further comprising shifting of the actuator via the control circuitry in increase a spring tension in a biasing element of the hybrid assisting force mechanism.
